(19) United States
(12) Patent Application Publication
(10) Pub. No.: US 2011/0164781 A1
(43) Pub. Date: Jul. 7, 2011

(54) MAGNETIC CIRCUIT FOR SPEAKER DEVICE AND SPEAKER DEVICE

(75) Inventors: Minoru Horigome, Yamagata (JP); Hiroyuki Kobayashi, Yamagata (JP); Toshihiro Hikichi, Yamagata (JP)

(73) Assignees: PIONEER CORPORATION, Tokyo (JP); TOHOKU PIONEER CORPORATION, Yamagata (JP)

(21) Appl. No.: 13/063,381

(22) PCT Filed: Oct. 27, 2008
(86) PCT No.: PCT/JP2008/069480

§ 371 Date: Mar. 10, 2011

(51) Int. Cl. H04R 1/00; H04R 9/06

(52) U.S. Cl. 381/398; 381/412

(57) ABSTRACT

A speaker device includes a diaphragm (2), frame (3) vibratably supporting the diaphragm (2) in the vibration direction, and a driving part (4) provided at the frame (3), applying vibration to the diaphragm (2) in response to an audio signal. The driving part (4) includes a magnetic circuit (40) forming a magnetic gap (40G) in a different direction in respect with the vibration direction of the diaphragm (2), a voice coil support part (6) having a voice coil (60) and vibrating along the magnetic gap (40G), and a vibration direction converter part (7) direction converting the vibration of the voice coil support part (6) and transmitting the vibration to the diaphragm (2). The magnetic circuit (40) includes a pair of magnetic gaps (40G, 40G) having different directions of magnetic flux. The pair of magnetic gaps (40G,40G) are arranged side by side in the vibration direction of the voice coil support part (6) and the voice coil (60) supported by the voice coil support part (6) is planarly arranged so as to itinerate in the pair of magnetic gaps (40G, 40G).

### FIELD OF THE INVENTION

The present invention relates to a magnetic circuit for a speaker device and the speaker device.

### BACKGROUND OF THE INVENTION

As a general speaker device, a dynamic speaker device as disclosed is known (for example, see patent literature 1). For example, as shown in FIG. 1, the dynamic speaker device described in this publication includes a frame 3J, a cone-shaped diaphragm 21J, an edge 4J which supports the diaphragm 21J to the frame 3J, a voice coil bobbin 610J joined to the inner periphery of the diaphragm 21J, a damper 7J which supports the voice coil bobbin 610J to the frame 3J, a voice coil 611J wound around the voice coil bobbin 610J, a yoke 51J, a magnet 52J, a plate 53J, and a magnetic circuit having a magnetic gap in which the voice coil 611J is arranged. In this speaker device, when an audio signal is inputted to the voice coil 611J, the voice coil bobbin 610J vibrates by the Lorentz force developed in the voice coil 611J in the magnetic gap and the diaphragm 21J is driven by the vibration.

[Patent literature 1] Publication of unexamined patent application H8-149596 (FIG. 1)

### DISCLOSURE OF THE INVENTION

### Problems to be Solved by the Invention

The general dynamic speaker device described above is, for example as shown in FIG. 1, configured such that the voice coil 611J is disposed opposite to the sound emission side of the diaphragm 21J, and the vibration direction of the voice coil 611J and the voice coil bobbin 610J is the same as the vibration direction of the diaphragm 21J. In such a speaker device, a region for vibration of the diaphragm 2J, a region for vibration of the voice coil bobbin 610J, and a region for arranging the magnetic circuit, etc. are formed along the vibration direction (sound emission direction) of the diaphragm 21J. Accordingly, the total height of the speaker device inevitably becomes comparatively large.

Specifically, as shown in FIG. 1, the dimension of the speaker device along the vibration direction of the diaphragm 21J is defined by: (a) the height of the cone-shaped diaphragm 21J along the vibration direction plus the total height of the edge 4J which supports the diaphragm 21J to the frame 3J, (b) the height of the voice coil bobbin from the junction of the diaphragm 21J and the voice coil bobbin 610J to the upper end of the voice coil 611J, (c) the height of the voice coil, (d) the height mainly of the magnet of the magnetic circuit, and (e) the thickness mainly of the yoke 51J of the magnetic circuit, etc. The speaker device as described above requires sufficient heights of (a), (b), (c), and (d) described above to ensure a sufficient vibration stroke of the diaphragm 21J. Further, the speaker device requires sufficient heights of (c), (d), and (e) described above to obtain a sufficient driving force. Accordingly, particularly in a speaker device for large volume, the total height of the speaker device inevitably becomes large.

Since the vibration direction of the voice coil bobbin 610J is the same direction as the vibration direction of the diaphragm 21J in conventional speaker devices as described above, the total height of the speaker devices inevitably becomes large to ensure the vibration stroke of the voice coil bobbin 610J, when seeking a large volume of sound by increasing the amplitude of the diaphragm 21J. Thus, it becomes difficult to make a device thin. In other words, making a device thin and securing a large volume of sound is contradictory.

To solve the above problem, the vibration direction of the voice coil is configured to be different from the vibration direction of the diaphragm such that the vibration direction of the voice coil is mechanically converted and the vibration is transmitted to the diaphragm. If this is realized, even though the vibration stroke of the voice coil becomes large, which will have little direct effect on the thickness of the speaker device, and thus a thin speaker device can be realized. In obtaining a thin speaker device as described above, the problem is how a driving system including a magnetic circuit is formed in a flat shape. The object of making it thin cannot be realized due to the increased thickness of the magnetic circuit simply by laying low a conventional cylindrical voice coil bobbin in a direction different than the vibration direction of a diaphragm. It is desired that a voice coil itself is formed in a plane shape so as to planarly move back and forth and the magnetic circuit is made thin in itself.

It is an object of the present invention to overcome the problem described above. That is, an object of the present invention is to provide a thin speaker device capable of emitting a loud reproduced sound with a comparatively simple configuration, obtain a plane shaped voice coil capable of realizing the thin speaker device and a thin magnetic circuit driving the voice coil, etc.

### Means for Solving the Problem

To achieve the above-mentioned object, a speaker device according to the present invention has at least a configuration according to the following each independent claim:
[claim 1]

A magnetic circuit for a speaker device transmitting vibration of a voice coil support part supporting a voice coil wound in a plane shape to a diaphragm via a rigid vibration direction converter part, the magnetic circuit for a speaker device planarly vibrating the voice coil support part, wherein a pair of magnetic gaps with different directions of magnetic flux are arranged side by side in the vibration direction of the voice coil support part.
[claim 12]

A speaker device, comprising a driving part including a voice coil wound in a plane shape, a voice coil support part supporting the voice coil and a magnetic circuit planarly vibrating the voice coil support part a diaphragm to which vibration of the driving part in response to an audio signal is transmitted a frame supporting the driving part and the diaphragm and a rigid vibration direction converter part provided between the voice coil support part and the diaphragm, direction converting vibration of the voice coil support part and transmitting the vibration to the diaphragm, wherein the magnetic circuit includes a pair of magnetic gaps having different directions of magnetic flux, wherein the pair of magnetic gaps are arranged side by side in the vibration direction of the voice coil support part, and the voice coil is arranged so as to itinerate in the pair of magnetic gaps.

### BRIEF DESCRIPTION OF THE DRAWINGS

FIG. 1 is a view illustrating a speaker device of a prior art;

FIG. 2 is a view illustrating a basic configuration of the speaker device according to an embodiment of the present invention;

FIG. 3 is a view illustrating a basic configuration (driving part) of the speaker device according to an embodiment of the present invention;

FIG. 4 is a view illustrating a basic configuration (driving part) of the speaker device according to an embodiment of the present invention;

FIG. 5 is a view illustrating a basic configuration (driving part) of the speaker device according to an embodiment of the present invention;

FIG. 6 is a view illustrating a basic configuration of the speaker device according to another embodiment of the present invention;

FIG. 7 is a view illustrating a basic configuration (driving part) of the speaker device according to another embodiment of the present invention;

FIG. 8 is a view illustrating a basic configuration (driving part) of the speaker device according to another embodiment of the present invention;

FIG. 9 is a view illustrating a basic configuration (operation of vibration direction converter part) of the speaker device according to an embodiment of the present invention;

FIG. 10 is a view illustrating a configuration example of magnetic circuit for the speaker device according to an embodiment of the present invention (FIG. 10(a) is a plan view, FIG. 10(b) is a cross-sectional view taken along line X1-X1, FIG. 10(c) is a back view and FIG. 10(d) is a front view);

FIG. 11 is a view illustrating a configuration example of magnetic circuit for the speaker device according to an embodiment of the present invention (FIG. 11(a) is a plan view, FIG. 11(b) is a cross-sectional view taken along line X1-X1, FIG. 11(c) is a back view and FIG. 11(d) is a front view);

FIG. 12 is a view illustrating a configuration example of magnetic circuit for the speaker device according to an embodiment of the present invention (FIG. 12(a) is a plan view, FIG. 12(b) is a cross-sectional view taken along line X1-X1, FIG. 12(c) is a back view and FIG. 12(d) is a front view);

FIG. 13 is a view illustrating a configuration example of magnetic circuit for the speaker device according to an embodiment of the present invention (FIG. 13(a) is a plan view, FIG. 13(b) is a cross-sectional view taken along line X1-X1, FIG. 13(c) is a back view and FIG. 13(d) is a front view);

FIG. 14 is a view illustrating a configuration example of magnetic circuit for the speaker device according to an embodiment of the present invention (FIG. 14(a) is a plan view, FIG. 14(b) is a cross-sectional view taken along line X1-X1, FIG. 14(c) is a back view and FIG. 14(d) is a front view);

FIG. 15 is a view illustrating a configuration example of magnetic circuit for the speaker device according to an embodiment of the present invention (FIG. 15(a) is a plan view, FIG. 15(b) is a cross-sectional view taken along line X1-X1, FIG. 15(c) is a back view and FIG. 15(d) is a front view);

FIG. 16 is a view illustrating a configuration example of magnetic circuit for the speaker device according to an embodiment of the present invention (FIG. 16(a) is a plan view, FIG. 16(b) is a cross-sectional view taken along line X1-X1, FIG. 16(c) is a back view, FIG. 16(d) is a front view and FIG. 16(e) is a modified view);

FIG. 17 is a view illustrating the speaker device according to another embodiment of the present invention;

FIG. 18 is a view illustrating the speaker device according to another embodiment of the present invention;

FIG. 19 is a view illustrating the speaker device according to another embodiment of the present invention (perspective view of the embodiment shown in FIG. 17);

FIG. 20 is a view illustrating distribution of the magnetic flux density (graph) of the magnetic circuit for the speaker device according to an embodiment of the present invention;

FIG. 21 is a view illustrating distribution of the magnetic flux density of the magnetic circuit for the speaker device according to an embodiment of the present invention (FIG. 21(a) shows dimension of each part and FIG. 21(b) shows a graph of the magnetic flux density);

FIG. 22 is a view illustrating distribution of the magnetic flux density of the magnetic circuit for the speaker device according to an embodiment of the present invention (FIG. 22(a) shows dimension of each part and FIG. 22(b) shows a graph of the magnetic flux density);

FIG. 23 is a view illustrating distribution of the magnetic flux density of the magnetic circuit for the speaker device according to an embodiment of the present invention (FIG. 23(a) shows dimension of each part and FIG. 23(b) shows a graph of the magnetic flux density);

FIG. 24 is a view illustrating distribution of the magnetic flux density of the magnetic circuit for the speaker device according to an embodiment of the present invention (FIG. 24(a) shows dimension of each part and FIG. 24(b) shows a graph of the magnetic flux density);

FIG. 25 is a view illustrating distribution of the magnetic flux density of the magnetic circuit for the speaker device according to an embodiment of the present invention (FIG. 25(a) shows dimension of each part and FIG. 25(b) shows a graph of the magnetic flux density);

FIG. 26 is a view illustrating an electronic device including the speaker device according to an embodiment of the present invention; and

FIG. 27 is a view illustrating a vehicle including the speaker device according to an embodiment of the present invention.

### PREFERRED EMBODIMENT OF THE INVENTION

A magnetic circuit for a speaker device according to an embodiment of the present invention is used for a speaker device transmitting vibration of a voice coil support part supporting a voice coil wound in a plane shape to a diaphragm via a rigid vibration direction converter part and vibrates the voice coil support part planarly, and a pair of magnetic gaps with different directions of magnetic flux are arranged side by side in the vibration direction of the voice coil support part.

According to this configuration, since a pair of magnetic gaps with different directions of magnetic flux is arranged side by side in the vibration direction of the voice coil support part, when voice currents flow through the voice coil wound in a plane shape, a Lorentz force is exerted on the voice coil in the vibration direction at the place where the voice coil is arranged so as to itinerate in the pair of the magnetic gaps. Accordingly, the voice coil support part planarly vibrates and the vibration of the voice coil support part is transmitted to the diaphragm via the vibration direction converter part, which enables the diaphragm to vibrate in a different direction in respect with the vibration direction of the voice coil support part.

Since this magnetic circuit for a speaker device can planarly vibrate the voice coil support part in a different direction in respect with the vibration direction of the diaphragm, the magnetic circuit can be configured such that vibration of the voice coil support part has little effect on the thickness in the sound emission direction of the speaker device, and thus a speaker device, which is thin in the sound emission direction, can be realized. Also, since a pair of magnetic gaps is arranged side by side in a different direction in respect with the vibration direction of the diaphragm, the size of the magnetic gap can be determined so as not to have a direct effect on the vibration direction of the diaphragm, and thus the magnetic circuit itself forming the magnetic gap can be made thin regardless of the vibration direction of the diaphragm.

Also this magnetic circuit for a speaker device includes yoke parts arranged in both opposite sides of a moving space of the voice coil support part and a magnet arranged so as to generate different directions of magnetic flux in the pair of magnetic gaps, and distribution of the magnetic flux of a pair of the magnetic circuits can be properly established depending on how the magnet is combined with the yoke parts disposed in the opposite sides. With the planar yoke parts configured on both sides of a moving space of the voice coil support part, the magnetic circuit will take up little space in a direction intersecting the vibration direction of the voice coil support part, and thus the magnetic circuit itself can be made thin.

Also, in this magnetic circuit for a speaker device, the yoke parts can be configured such that the end parts of the yoke parts are connected so as to surround the moving space of the voice coil support part. In this case, since the periphery of the magnetic gap is surrounded by the yoke parts, vibration of the voice coil support part will hardly interfere with a neighboring member. Also, magnetic flux density of the magnetic gap can be increased while forming an opening part passing through the moving space of the voice coil support part.

Also, in this magnetic circuit for a speaker device, the yoke part can be configured such that the end part of the yoke part is supported by a spacer formed with nonmagnetic body. In this case, since the yoke parts disposed in the opposite sides can be divided into two members, a complicated process of the yoke parts is unnecessary, and the spacer formed with nonmagnetic body is constructed with a part of the frame of the speaker device such that the moving space of the voice coil support part can be increased in the installation space. Also, even when using a magnet generating a comparatively small magnetic force, magnetic flux density in the magnetic gap can be effectively increased.

Also, in this magnetic circuit for a speaker device, at least one of the pair of magnetic gaps can be formed between the yoke parts, and at least one of the pair of magnetic gaps can be formed between the two magnets. Distribution of magnetic flux in the magnetic gap can be variously established depending on arrangement of the magnet with respect to the magnetic gap.

Also, this magnetic circuit for a speaker device includes the yoke parts oppositely arranged in both sides of a moving space of the voice coil support part and the magnets connected with the yoke parts, arranged to project toward each of the pair of magnetic gaps, and the magnetic circuit for a speaker device can be configured such that magnetization directions of the magnets are reversed for each magnetic gaps. In this case, two-time magnetizations for each magnet are performed such that each magnet is configured to be magnetized in the opposite direction. According to this configuration, a pair of magnetic gaps can be configured so as to generate substantially symmetrical distribution of magnetic flux with respect to the center of the vibration direction of the voice coil support part, and thus a driving force can be efficiently applied to the voice coil support part.

Also, this magnetic circuit for a speaker device can form the magnetic gap between the magnet and the yoke part or between the magnet and a protruding part projecting from the yoke part. If the magnetic gap is formed between the magnet and the yoke part, the magnetic gap extending toward the yoke parts can be formed by making the yoke parts flat. If the magnetic gap is formed between the magnet and a protruding part projecting from the yoke part, the magnetic gap, in which magnetic flux is concentrated between the magnet and the protruding part, can be formed.

Also, this magnetic circuit for a speaker device includes yoke parts arranged in both opposite sides of a moving space of the voice coil support part, a magnet connected to the yoke part, arranged to project so as to form one of the pair of magnetic gaps, and a protruding part projecting from the yoke parts so as to form the other of the pair of magnetic gaps. According to this configuration, instead of providing magnets in both sides of the magnetic gap, the magnet in one side of the magnetic gap can be changed into the protruding part of the yoke part.

Also, one of a pair of magnetic gaps is formed between a pair of the magnets, while the other of the pair of magnetic gaps is formed between a pair of the protruding parts. Alternatively, one of a pair of magnetic gaps is formed between one of the magnets and the yoke part, while the other of the pair of magnetic gaps is formed between one of the protruding parts and the yoke part. With the magnetic circuit configured as above, magnets can be arranged consolidated in one side of the magnetic gaps, thereby magnetization can be at one time. By reducing the number of times of magnetization, dust, etc. can be prevented from entering a magnetic circuit, reliability of the speaker device can be improved, and also manufacturing process can be simplified.

A speaker device according to the embodiment of the present invention includes a driving part including a voice coil wound in a plane shape, a voice coil support part supporting the voice coil and a magnetic circuit planarly vibrating the voice coil support part, a diaphragm to which vibration of the driving part in response to an audio signal is transmitted, a frame supporting the driving part and the diaphragm, and a rigid vibration direction converter part provided between the voice coil support part and the diaphragm, direction converting vibration of the voice coil support part and transmitting the vibration to the diaphragm, and the magnetic circuit includes a pair of magnetic gaps having different directions of magnetic flux. The pair of magnetic gaps is arranged side by side in the vibration direction of the voice coil support part, and the voice coil is arranged so as to itinerate in the pair of magnetic gaps.

According to the speaker device as described above, when an audio signal is inputted to the voice coil of the driving part, a Lorentz force is generated in the voice coil arranged in the magnetic gap of the magnetic circuit, and the voice coil support part vibrates in a different direction in respect with the vibration direction of the diaphragm, preferably in the direction orthogonally to the vibration direction of the diaphragm. In response to the above vibration, a vibration direction converter part serves to direction convert the vibration of the voice coil support part and transmits the vibration of the voice coil support part to the diaphragm. The diaphragm vibrates in a different vibration direction in respect with the voice coil support part (for example, orthogonally to the voice coil support part) due to the driving force transmitted via the vibration direction converter part.

In a typical speaker device, for example, a voice coil bobbin is arranged in the back side of the diaphragm such that the vibration direction of the diaphragm and the vibration direction of the voice coil bobbin are aligned. Since the diaphragm and the voice coil bobbin require their respective space for vibration in the vibration direction, the length in the sound emission direction of the speaker device is comparatively large. In contrast, the speaker device according to an embodiment of the present invention includes a magnetic circuit having a magnetic gap formed in a different direction in respect with the vibration direction of the diaphragm, preferably in a direction orthogonally to the vibration direction of the diaphragm, a voice coil support part vibrating along the magnetic circuit, and a vibration direction converter part direction converting the vibration direction of the voice coil support part and transmitting the vibration to the diaphragm, and thus the length in the sound emission direction is comparatively small compared to the above conventinal speaker device. That is, a thin speaker device can be provided. Further, since a vibration stroke of the voice coil support part can be arranged in a direction having little effect on the total length of the speaker device, the speaker device can be easily made thin even when the vibration stroke of the voice coil support part, that is, the amplitude of vibration of the diaphragm is made large. This will enable a speaker device to be made thin while producing a loud sound.

Further, in the speaker device according to an embodiment of the present invention, in the magnetic circuit a pair of magnetic gaps with different directions of magnetic flux are arranged side by side in the vibration direction of the voice coil support part and the voice coil supported by the voice coil support part is arranged planarly so as to itinerate in the pair of magnetic gaps. Therefore, a magnetic circuit can be configured such that the voice coil wound in a plane shape vibrates along the plane of the voice coil, which will enable the voice coil and the magnetic circuit itself to be made thin, and a driving system in which vibration of the voice coil have little effect on the thickness direction of the speaker device, can be realized.

Further, in the speaker device according to an embodiment of the present invention, the voice coil includes a pair of substantially parallel straight portions, and each of the pair of straight portions is arranged to intersect the direction of magnetic flux in the pair of magnetic gaps respectively. According to this configuration, a Lorentz force is exerted on the pair of straight portions that are substantially parallel in substantially the same direction due to voice currents flowing through the voice coil, thus planar vibration can be effectively applied to the voice coil and the voice coil support part.

Also, in the speaker device according to an embodiment of the present invention, the magnetic circuit includes the yoke parts and the magnet arranged oppositely in both sides of a moving space of the voice coil support part. According to this configuration, since the magnetic circuit can be configured so as straddle the moving space of the voice coil support part, the magnetic circuit will take up little space in the direction intersecting the vibration direction of the voice coil support part, and thus the speaker device can be made thin.

The yoke parts include a support part partially projecting in a direction intersecting the vibration direction of the voice coil support part, and the support part is supported by the frame. According to this configuration, the yoke part can be supported by the frame at a prescribed distance therefrom by using the support part, and therefore when two yoke parts are provided at both sides of the moving space of the voice coil support part, they can be effectively installed.

Also, in the speaker device according to an embodiment of the present invention, the vibration direction converter part includes a link body that angle converts a link part arranged between the voice coil support part and the diaphragm, and the link body angle converts the link part in response to a reaction force exerted from the static part located in the opposite side of the diaphragm. According to this configuration, the vibration direction converter part includes a link body that angle converts a link part arranged between the voice coil support part and the diaphragm in response to vibration of the voice coil support part and a reaction force exerted from the static part. This will enable secure transmission of the vibration of the voice coil support part to the diaphragm while receiving a reaction force from the static part, and therefore preferable transmission efficiency of vibration can be obtained even when the vibration direction of the voice coil and the vibration direction of the diaphragm differs and preferable reproduction efficiency of the speaker device can be obtained. Particularly, vibration of the voice coil being securely transmitted to the diaphragm, preferable reproduction characteristic can be obtained in the high frequency range. The vibration direction of the voice coil support part is converted to the direction orthogonally thereto and the vibration is transmitted to the diaphragm, which will enable the speaker device to be effectively made thin.

Also, in the speaker device according to an embodiment of the present invention, the vibration direction converter part converts the vibration direction of the voice coil support part to the direction orthogonally thereto and transmits the vibration to the diaphragm. According to this configuration, the voice coil support part is vibrated in the direction orthogonally to the sound emission direction, and thereby amplitude of vibration of the voice coil support part can be secured regardless of the thickness in the sound emission direction of the speaker device, which will enable the speaker device to be made thin while producing a loud sound.

Also, in the speaker device according to an embodiment of the present invention, the static part is a part of the frame, the frame includes a bottom face having a plane shape, the diaphragm is planarly supported along the bottom face of the frame, the magnetic gap is formed along the bottom face of the frame, and the vibration direction converter part vibrates the diaphragm in the direction intersecting the bottom face due to a reaction force from the bottom face of the frame. According to this configuration, the magnetic gap is formed along the bottom face of the frame, and a magnetic circuit can be made thin to form the magnetic gap, thereby the speaker device can be made thin while the vibration of the voice coil support part can be securely direction converted and the vibration can be transmitted to the diaphragm.

Also, in the speaker device according to an embodiment of the present invention, a pair of the driving parts is provided, and the vibration direction converter part are disposed in the opposite sides substantially symmetrically to each other. According to this configuration, a combination of driving force of a pair of the driving parts can vibrate a single diaphragm, and thus the speaker device can be made thin while the diaphragm can vibrate due to an increased driving force.

The speaker device according to the present invention can be used for various devices such as mobile phones, in-vehicle speakers, speakers for personal computers, and speakers for television broadcasting receivers.

Hereinafter, a speaker device according to one embodiment of the present invention is described with reference to the drawings.

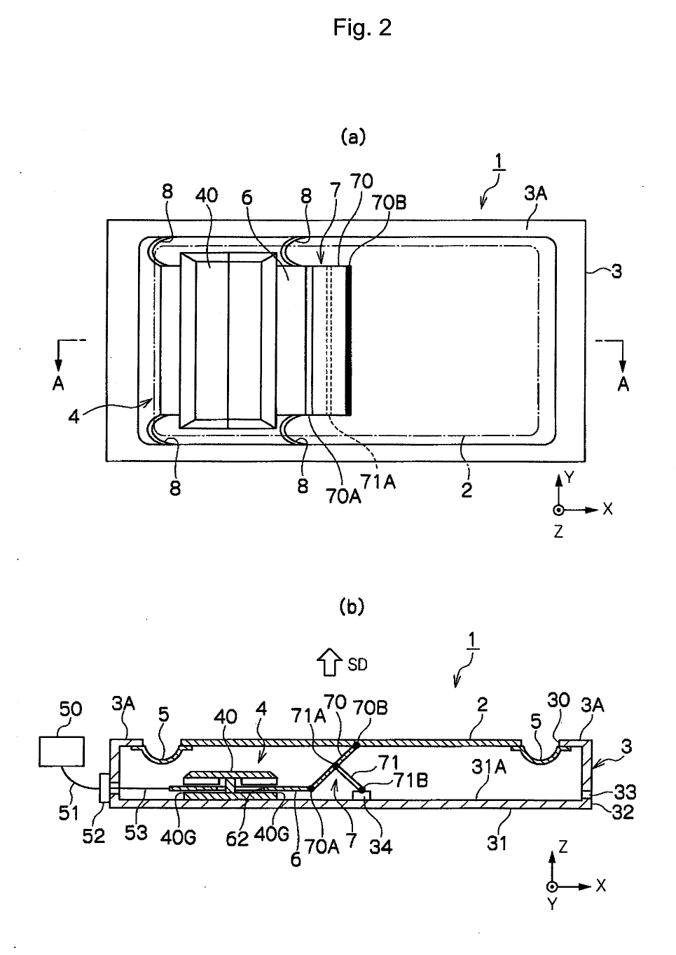

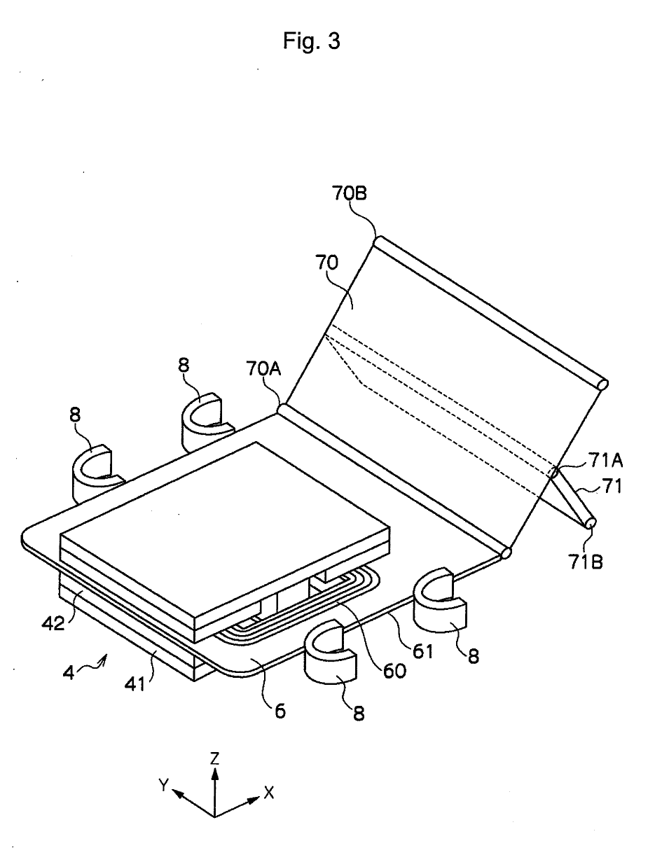

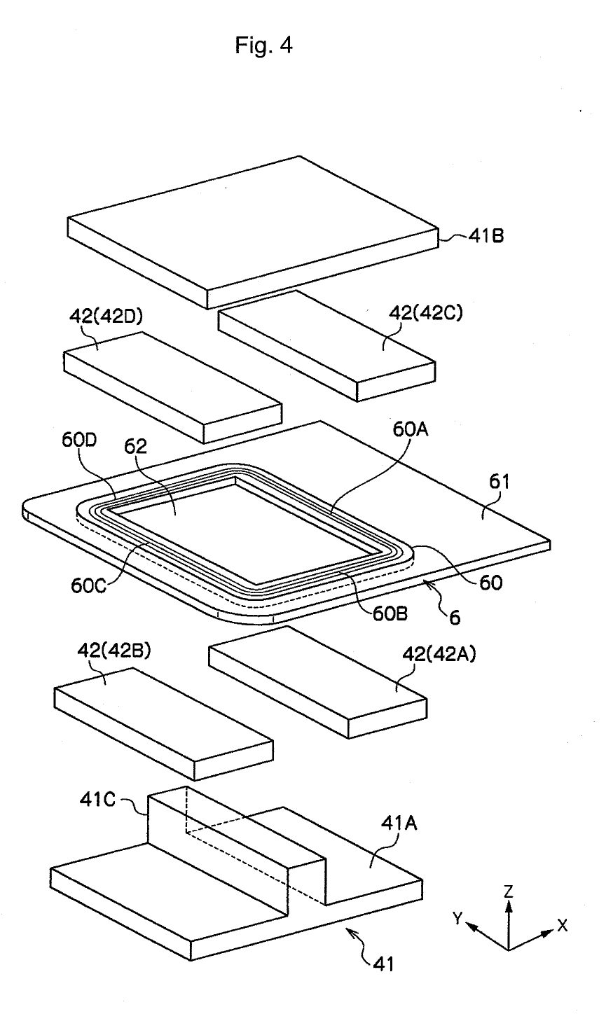

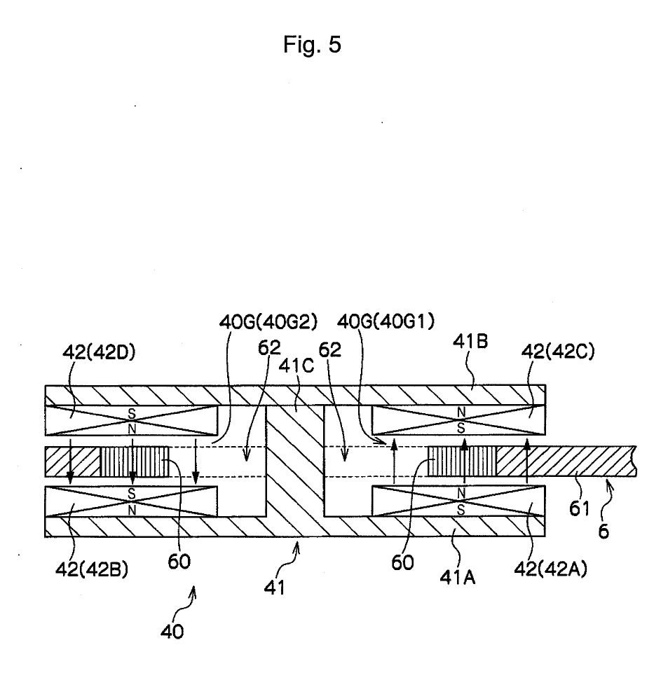

FIGS. 2 to 5 are views illustrating a basic configuration of the speaker device according to an embodiment of the present invention. FIG. 2(a) is a plan view (the diaphragm is shown in virtual lines, thus illustrating a state omitting the diaphragm), FIG. 2(b) is a sectional view of FIG. 2(a) taken along line A-A. FIGS. 3 to 5 are views illustrating a driving part (FIG. 3 is a perspective view, FIG. 4 is an exploded perspective view, and FIG. 5 is a sectional view). Hereinafter, a sound emission direction (SD) is defined as Z-axis, a longitudinal direction of the speaker device is defined as X-axis, and a direction perpendicular to both X-axis and Z-axis is defined as Y axis.

A speaker device 1 according to an embodiment of the present invention has a diaphragm 2, a frame 3, and a driving part 4 as principal components. The outer periphery of the diaphragm 2 is supported through the edge 5 with the outer periphery 3A of the frame 3. The function of the edge 5 is to basically define the vibration of the diaphragm 2 exclusively in the Z-axis direction. When an audio signal is applied to the driving part 4, the driving part 4 is driven, and a vibration developed by the driving is transmitted to the diaphragm 2.

The driving part 4 includes a magnetic circuit 40, a voice coil supporting part 6, and vibration-direction-conversion part 7. The magnetic circuit 40 has a magnetic gap 40G formed in a direction (for example, X-axis direction) different from the vibration direction of the diaphragm 2 (for example, Z-axis direction). In an example shown in the drawing, the magnetic gap 40G is formed along the direction perpendicular to the vibration direction of the diaphragm 2, however the configuration is not limited to the example. The voice coil supporting part 6 has a voice coil 60 and is configured to vibrate along the magnetic gap 40G. The movement of the voice coil supporting part 6 is restricted by a damper 8 only in the direction along the magnetic gap 40G. When an audio signal is applied to the voice coil 60, the Lorenz force is developed in the voice coil 60 in the magnetic gap 40G, thereby causing the voice coil supporting part 6 integral with the voice coil 60 to vibrate.

The vibration direction converter part 7 direction converts the vibration of the voice coil support part 6 and transmits the vibration of the voice coil support part 6 to the diaphragm 2. The vibration direction converter part 7 includes a link body described below and converts the angle of a link part (first link part) 70 formed between the voice coil support part 6 and the diaphragm 2 in response to the vibration of the voice coil support part 6 and a reaction force received from the frame 3 that can be the static part against the vibration of the voice coil support part 6.

In accordance with this embodiment according to the present invention, for example, an audio signal is transmitted from an audio signal source 50 to a terminal 52 provided in proximity of the frame 3 through a signal wire 51. The audio signal is further transmitted from the terminal 52 to the voice coil 60 of the voice coil supporting part 6 through the signal wire 53. Upon the audio signal inputted in the voice coil 60, the voice coil supporting part 6 vibrates along a magnetic gap 40G formed in a direction different from the allowed vibration direction of the diaphragm 2, and this vibration is direction-converted and transmitted to the diaphragm 2 by the vibration-direction-conversion part 7, thereby vibrating the diaphragm 2 to emit a sound corresponding to the audio signal in a sound emission direction (SD).

At this time, since the direction of the magnetic gap 40G is configured to cross the vibration direction of the diaphragm 2 and the thickness direction of the speaker device 1, an increase of the driving force of the magnetic circuit 40 or the vibration stroke of the voice coil supporting part 6 has directly little effect on the size of the speaker device 1 in the thickness direction (Z-axis direction). Accordingly, it becomes possible to make the speaker device in a thin shape while enabling a large volume. Further, it is structurally possible to make the speaker device 1 thinner than the vibration stroke (displacement) of the voice coil supporting part 6, thus the structure facilitates to produce a thin speaker device.

Further, since the vibration-direction-conversion part 7 is configured to convert the vibration direction of the voice coil supporting part 6 and transmit the vibration to the diaphragm 2 through a mechanical link body, the transmission efficiency of the vibration is high. Furthermore, since the angle conversion of the link part 70 is performed upon receiving the reaction force from the frame 3 as the stationary part against the vibration of the voice coil supporting part 6, the vibration of the voice coil supporting part 6 can be more securely transmitted to the diaphragm 2. This will enable the speaker device 1 to attain good reproduction efficiency, and in particular it will be possible to obtain good reproduction characteristic in high-tone range by securely transmitting the vibration of the voice coil 60 to the diaphragm 2.

Hereinafter, each of the components of the speaker device 1 according to the embodiment is described in detail.

### [Frame 3]

The frame 3 supports the diaphragm 2 vibratably in the vibration direction and supports the driving part 4 therein. The frame 3 supports a part of a link body of the vibration-direction-conversion part 7 and, thus applies a reaction force corresponding to the operation of the link body to the link body. Such a frame 3 preferably includes a planar bottom face 31A.

Also, the frame 3 is a stationary part that is arranged to be stationary with respect to the voice coil supporting part 6. The stationary part, however is not necessary to be completely stationary and may be stationary enough to support the diaphragm 2, thus the vibration caused at the time of driving the speaker device 1 may be transmitted to generate a vibration in the whole stationary part. Further, the stationary part may be arranged mechanically integrally with the after-mentioned magnetic circuit 40, and since the frame 3 is supported by the magnetic circuit 40 in a sense, the frame 3 can be stationary in this respect. Moreover, the members constituting the magnetic circuit 40 and other members supported by the magnetic circuit 40 may become a stationary part.

The frame 3 as shown in FIG. 2 is formed planarly in a rectangular shape and cross-sectionally in a concave shape when it is viewed from the sound emission direction (SD). As described in the drawings, specifically the frame 3 includes a planarly rectangular bottom plate 31, a tubular part 32 standing up toward the sound emission direction (SD) from the outer periphery of the bottom plate 31, and an opening 30 formed in the upper side. The magnetic circuit 40 is arranged on the bottom plate 31, the outer periphery of the edge 5 is joined to the upper end of the tubular part 32 with an adhesive or the like, and the diaphragm 2 supported through the edge 5 is arranged within the opening 30. In the example shown in the drawing, a flat outer periphery 3A extending inward is formed in proximity of the upper end of the tubular part 32 and the edge 5 is connected to this outer periphery 3A. Conventionally known materials such as resin and metal may be adopted as the material of the frame 3.

Further, as shown in FIG. 2(b), a through-hole 33 is formed, for example in the side surface or the bottom surface of the frame 3. The through-hole 33 functions, for example as a vent hole. For example, if the vent hole is not provided, air within the space enclosed by the diaphragm 2 and the frame 3 may act as a spring according to the vibration of the diaphragm 2 when the speaker is driven. This may suppress the vibration of the diaphragm 2 as a result. In contrast, in the example shown in the drawing, since the through-hole 33 is provided, such a suppression of the vibration applied to the diaphragm 2 may be avoided. In addition, the through-hole 33 may function to release heat of the magnetic circuit 40 or the voice coil 60. Furthermore, the through-hole 33 may be used as passages through which a signal wire is disposed to electrically connect the voice coil 60 to an audio signal source 50 such as an amplifier, an equalizer, a tuner, a broadcasting receiver and a television, which are provided outside the speaker device, for example.

### [Diaphragm 2]

The diaphragm 2 is vibratably supported by the frame 3 in the vibration direction (Z-axis direction), as shown in FIG. 2(b). The diaphragm 2 emits a sound wave in the sound emission direction (SD) when the speaker is driven. The diaphragm 2 is supported by the frame 3 through the edge 5, and movements in directions other than the vibration direction, specifically in the X or Y direction, are restrained by the edge 5. The edge 5 and the diaphragm 2 may be integrally formed.

The diaphragm 2 may be made of, for example, a resin, a metal, a paper, a ceramic, or a composite material. The diaphragm 2 preferably has rigidity for example. The diaphragm 2 may be formed in a predetermined shape such as a tabular shape, a dome shape, a cone shape, and so on. In the example shown in the drawing, the diaphragm 2 is formed in a plate shape, and is supported along the planar bottom face 31A of the frame 3. The diaphragm 2 formed in a tabular shape is particularly preferable for the embodiment of the present invention which has a problem to be solved in realizing a thin speaker device. Also, the shape of the diaphragm 2 as viewed from the sound emission direction (SD) (planar shape) is formed in a predetermined shape such as a rectangular, elliptical, circular, polygonal shape and so on. In the example shown in the drawings, the tabular shape of the diaphragm 2 is formed in a rectangular shape.

Since the diaphragm 2 is vibratably supported by the frame 3 and the space enclosed by the diaphragm 2 and the frame 3 at the back side (opposite to the sound emission direction) of the diaphragm 2 is blocked off in the sound emission direction, it is possible to suppress the emission toward the sound emission direction of sound waves from the back of the diaphragm 2.

### [Edge 5]

The edge 5 is arranged between the diaphragm 2 and the frame 3, and the inner periphery part thereof supports the outer periphery of the diaphragm 2 and also holds the diaphragm 2 in a predetermined position by joining the outer periphery to the frame 3. Specifically, the edge 5 supports the diaphragm 2 vibratably in the vibration direction (Z-axis direction) and restrains a vibration in a direction perpendicular to the vibration direction. The edge 5 shown in the drawing is formed in a ring shape (annular shape) as viewed from the sound emission direction. As shown in FIG. 2(b), the edge 5 has a predetermined cross-sectional shape, such as convex, concave, or corrugated shape. In this embodiment, the edge 5 is formed in a concave shape toward the sound emission direction, but not limited thereto. The edge 5 may be formed in a convex shape in the sound emission direction. The edge 5 may be made of, for example, leather, a fabric, rubber, a resin, or each of which is sealed with a filler or rubber, otherwise a member of rubber or a resin formed into a predetermined shape, or the like.

### [Magnetic Circuit 40]

The magnetic circuit 40 is arranged in the frame 3. The magnetic circuit 40 shown in the drawing is housed in the frame 3 as shown in FIG. 2(b), and the magnetic gap 40G is formed along the planar bottom face 31A of the frame 3. For example, an inner-magnet type magnetic circuit or an outer-magnet type magnetic circuit may be used as the magnetic circuit 40.

As a specific structure, the magnetic circuit 40 includes a yoke 41 and a magnet 42 as shown in FIGS. 4 to 5. The magnetic circuit 40 shown in the drawing includes a plurality of magnets 42A to 42D. In the magnetic circuit 40, the magnets 42 are provided on both sides of the magnetic gap 40G in the magnetic field direction. For example, the magnetic gap 40G is formed along the X-axis direction such that the voice coil 60 can move within a predetermined range along the X-axis direction.

The yoke 41 includes a lower flat part 41A, an upper flat part 41B, and a support 41C. The lower flat part 41A and the upper flat part 41B are arranged substantially parallel to each other with a predetermined interval between them, and the support 41C is formed in the center such that it extends in a substantially perpendicular direction with respect to the lower flat part 41A and the upper flat part 41B.

The lower flat part 41A may be formed in a shape so as to support the diaphragm 2, the edge 5, etc. in place of the above-mentioned frame 3. Specifically, the lower flat part 41A is formed in a concave cross-sectional shape, and it may be configured to include a bottom plate part having a rectangular shape in the planar shape, a tubular part having a rectangular shape in a planar shape and standing from the outer periphery part of the bottom plate part in the sound emission direction (SD) and an opening part formed at the upper side. In this case, the lower flat part 41A can be the static part.

When an audio signal (current) flows in the voice coil 60 in the magnetic field of the magnetic gap 4G, the Lorentz force is developed in a direction perpendicular to each of the magnetic field direction and the electric current direction according to the Fleming's left-hand rule. In the speaker device 1 according to this embodiment, the voice coil 60 and the magnetic circuit 40 are configured such that the Lorentz force is developed in the voice coil 60 in a predetermined direction different from the vibration direction of the diaphragm 2, specifically, in a direction (X-axis direction) perpendicular to the vibration direction of the diaphragm 2 (Z-axis direction) to vibrate the voice coil 60 in the X-axis direction. The magnets 42A to 42D are arranged on the flat parts 41A and 41B. One magnetic gap 40G1 is formed by the magnets 42A and 42C while the other magnetic gap 40G2 is formed by the magnets 42B and 42D. This pair of magnetic gaps 40G1 and 40G2 is planarly formed side by side such that magnetic fields opposite to each other are generated.

The annular voice coil 60 according to this embodiment has a substantially rectangular shape as viewed from the sound emission direction (SD), and is configured to have straight parts 60A and 60C formed in the Y-axis direction and straight parts 60B and 60D formed in the X-axis direction. The straight parts 60A and 60C of the voice coil 60 are arranged in the magnetic gap 40G of the magnetic circuit 40 so as to generate a magnetic field in the Z-axis direction. It is preferable not to apply a magnetic field to the straight parts 60B and 60D of the voice coil 60. Also, even when magnetic fields are applied to the straight parts 60B and 60D, they are applied so that the Lorentz force developed in the straight parts 60B and 60D can cancel each other.

Further, since the voice coil 60 according to this embodiment is formed in a tabular shape of a thin plate, it is possible to make a portion in the magnetic gap 40G comparatively large by increasing the winding number and thereby obtain a comparatively strong driving force when the speaker is driven.

In the magnetic circuit 40 according to this embodiment, a plurality of magnets 42A to 42D are magnetized such that the direction of a magnetic field in the straight part 60A of the voice coil 60 is opposite to the direction of a magnetic field in the straight part 60C as shown in FIG. 5. Also, the voice coil 60 according to this embodiment is configured in an annular shape such that an audio signal flowing in the straight part 60A and an audio signal flowing in the straight part 60C of the voice coil 60 are opposite to each other in direction.

In the speaker device 1 having the above configuration, when an audio signal is inputted to the voice coil 60, the Lorentz forces developed in the straight part 60A and straight part 60C are in the similar direction, and therefore a driving force is twice as strong as in such a configuration that, for example, a magnetic field is applied to only one of the straight parts 60A and 60C. Accordingly, using the magnetic circuit 40 and the voice coil 60 configured as described above, the speaker device 1 can be configured in a comparatively thin shape and also can obtain a comparatively strong driving force.

### [Voice Coil Supporting Part 6]

The voice coil supporting part 6 includes the above-mentioned voice coil 60 wound in a plane shape and is formed to be movable along a direction different from the vibration direction of the diaphragm 2. In the embodiment shown in the drawing, the voice coil supporting part 6 is vibratably arranged along the magnetic gap 40G that is formed along the planar bottom face 31A of the frame 3. More specifically, the voice coil supporting part 6 of this embodiment is formed to be movable only in the X-axis direction and to be restrained in movements in other directions. The moving range of the voice coil supporting part 6 is restrained by dampers 8 as a restraint part in this embodiment, but is not limited to this embodiment. For example, the restraint element may be formed by using a rail, a guide member, a groove, or the like.

Further, the voice coil supporting part 6 includes the voice coil 60 arranged in the magnetic gap 40G of the magnetic circuit 40, and a planar insulating member 61 in form of extending from the voice coil 60 to outside of the magnetic gap 40G along the moving direction of the voice coil 60. Also, the voice coil supporting part 6 has an opening 62 and the voice coil 60 is arranged along the outer periphery of the opening 62. Since the voice coil supporting part 6 as configured above may have such a structure that the voice coil 60 is embedded into the insulating member 61, it is possible to reinforce the strength of the voice coil 60 and thereby reduce the distortion of the voice coil 60.

In this embodiment shown in the drawing, the opening 62 is loosely fitted to the support part 41C of the magnetic circuit 40 and the moving range of the voice coil supporting part 6 is restrained in this state. Specifically, the opening part 62 is formed in a rectangular shape and the interval between the sides along the moving direction of the voice coil supporting part 6 is substantially equal to or longer than the width of the support part 41C, and the interval between the sides in a direction perpendicular to the moving direction is relatively long in accordance with the moving range of the voice coil supporting part 6.

### [Vibration-Direction-Conversion Part 7]

The vibration-direction-conversion part 7 includes a link body to angle-convert a link part (first link part) 70 formed between the voice coil supporting part 6 and the diaphragm 2 by using the vibration of the voice coil supporting part 6 and a reaction force received from the frame 3. Specifically, with reference to FIGS. 2 and 3, the vibration-direction-conversion part 7 includes a first link part 70 and a second link part 71. One end of the first link part 70 is a hinge part 70A between the first link part 70 and the voice coil supporting part 6 and the other end thereof is a hinge part 70B between the first link part 70 and the diaphragm 2. One end of the second link part 71 is a hinge part 71A between the second link part 71 and the middle portion of the first link part 70 while the other end is a hinge part 71B between the second link part 71 and the frame 3. The first link part 70 and the second link part 71 are obliquely arranged in directions different from the vibration direction of the voice coil supporting part 6 (for example, X-axis direction).

These link parts are a part to form the link body and basically are not flexible (having rigidity). Each of them has hinge parts at its both ends. The hinge parts can be formed by rotatably joining two members or by forming one member as a folding part that is foldable in any given angle. In the embodiment shown in the FIG. 2(b), the hinge part 71B is formed on a supporting part 34 (stationary part) formed protrudingly on the bottom face 31A of the frame 3.

In the embodiment as shown in FIGS. 2 and 3, the link body is formed by the first link part 70, the second link part 71, and the hinge parts 70A, 70B, 71A and 71B. In this embodiment, the hinge part 71B between the second link part 71 and the frame 3 is not displaceable, while other hinge parts 70A, 70B and 71A are displaceable. Thereby, the link body as the whole is structured to receive a reaction force from the frame 3 at the hinge part 71B. In this link body, when the hinge part 70A moves in the X-axis direction according to the vibration of the voice coil supporting part 6, the hinge part 70B moves along the Z-axis direction, thus the vibration of the voice coil supporting part 6 is direction-converted and transmitted to the diaphragm 2.

The vibration-direction-conversion part 7 according to the embodiment of the present invention can be formed by a plate member having a line-shaped folding part and the folding part may be the above-mentioned hinge part of the link body. Specifically, the first link part 70 and the second link part 71 can be formed with the plate members, while the hinge parts 70A, 70B, 71A and 71B of the link body can be formed by the line-shaped folding parts as shown in the drawings. According to this configuration, it is possible to join the first link part 70 to the diaphragm 2 in a line shape, which enables to apply the vibration to the planar diaphragm 2 uniformly along its width direction and vibrate the whole diaphragm 2 substantially in the same phase. In other words, this can suppress occurrence of a divided vibration, making it possible to reproduce a sound particularly in the high-tone range. In addition, each link part has a rigidity, which enables to suppress occurrence of vibrations in an eigen-frequency mode, thus preventing deflection vibration of the link part or the like from adversely affecting the vibration of the diaphragm 2, thereby suppressing deterioration of acoustic characteristic.

The vibration-direction-conversion part 7 according to this embodiment may have the vent hole for example, though not shown in the drawings. The vent hole can reduce local fluctuations of air pressure in the space enclosed by the diaphragm 2 and the frame 3 and prevents the damping of the vibration-direction-conversion part 7 due to air pressure. Further, a through-hole is formed for example on the link part by making the vent hole, which can reduce the weight of the link part and enables reproduction in high-tone range. Reducing the weight of the vibration-direction-conversion part 7 can effectively broaden bandwidth of reproduction characteristic and increase the amplitude of a sound wave and the sound pressure level with respect to a predetermined voice current. With the vent hole formed at the link part, air pressure (damping force) exerted on the link part can be made comparatively small.

Further, vibration-direction-conversion part 7 may be constituted by an integral part connected at the folding part. In this case, the vibration-direction-conversion part 7 forming a complex link body can be instantly joined to the voice coil supporting part 6 or the diaphragm 2, which improves the assembly performance of the speaker device. Furthermore, the vibration-direction-conversion part 7 may be formed integrally with the voice coil supporting part 6 or the diaphragm 2 as well, for example.

### [Damper 8]

Damper 8 holds the voice coil supporting part 6 at a predetermined position within the magnetic gap 40G such that the voice coil supporting part 6 does not contact the magnetic circuit 40, and also vibratably supports the voice coil supporting part 6 along the vibration direction (X-axis direction). The damper 8 restrains movements such that the voice coil supporting part 6 does not move in directions different from the vibrating direction of the voice coil supporting part 6, for example in the Z or Y-axis direction.

The damper 8 according to this embodiment is, for example, formed in a shape of a plate and thus has flexibility. Also, the damper 8 may be formed to have a cross-section in a shape among various cross-sectional shapes such as a convex, a concave, and a corrugated shape, and the thickness thereof may either be uniform or nonuniform. The damper 8 joins to the voice coil supporting part 6 at one end and joins to the frame 3 at the other end. The damper 8 is not limited to this embodiment, and may be configured to join to the voice coil supporting part 6 at one end and join to the magnetic circuit 40 at the other end for example.

It is also possible to provide a rail, a groove, a step, a guide member, or the like in place of the above-mentioned damper 8 on the frame 3 for the movement restraint or the support of the voice coil supporting part 6. That is, the speaker device 1 may have such a structure that the voice coil supporting part 6 slides with an end of the voice coil supporting part 6 being fitted into a rail, a groove, a step, or the like.

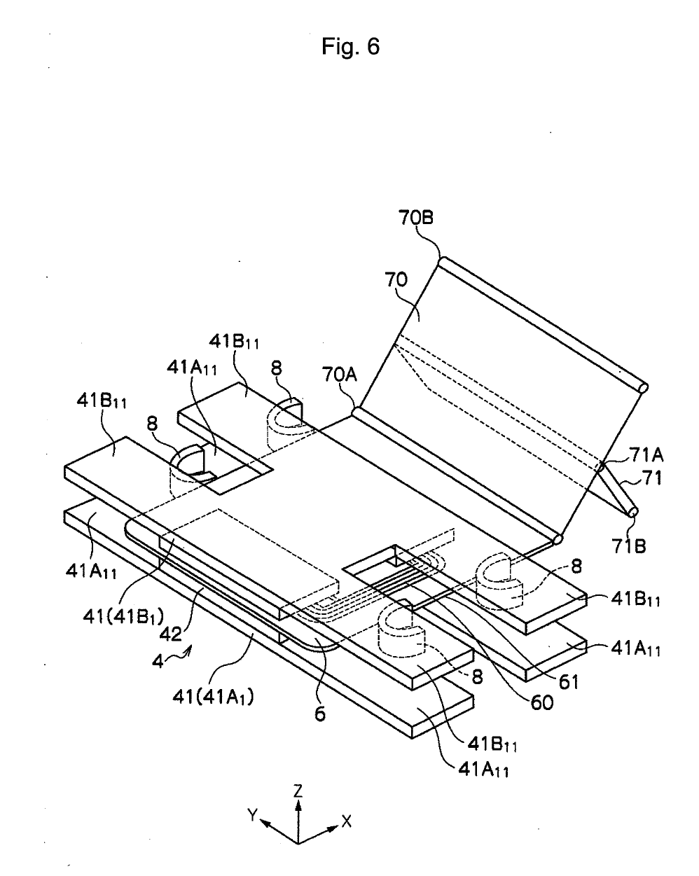

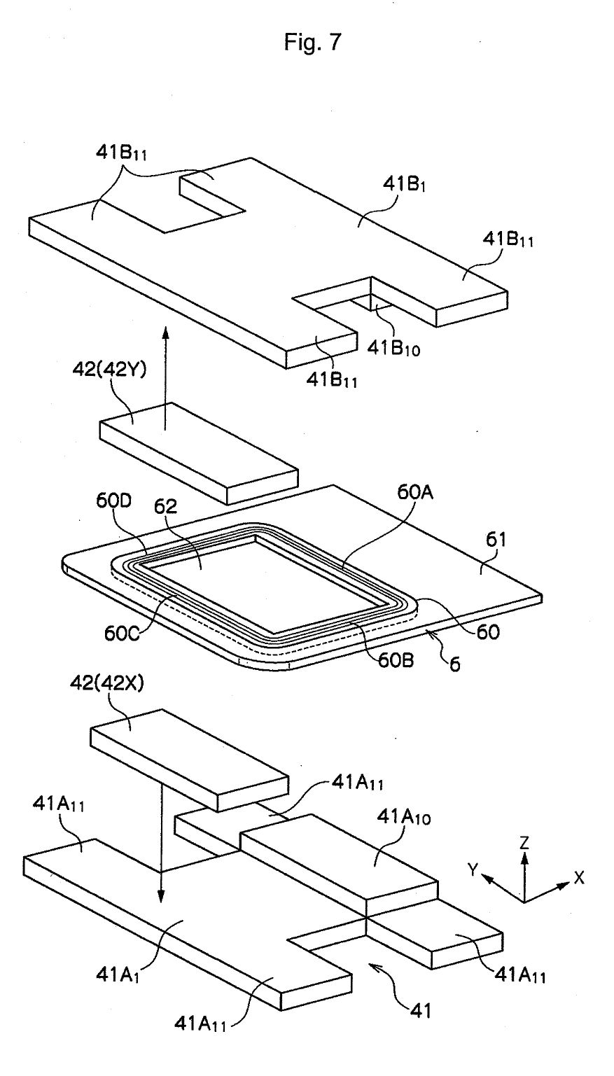

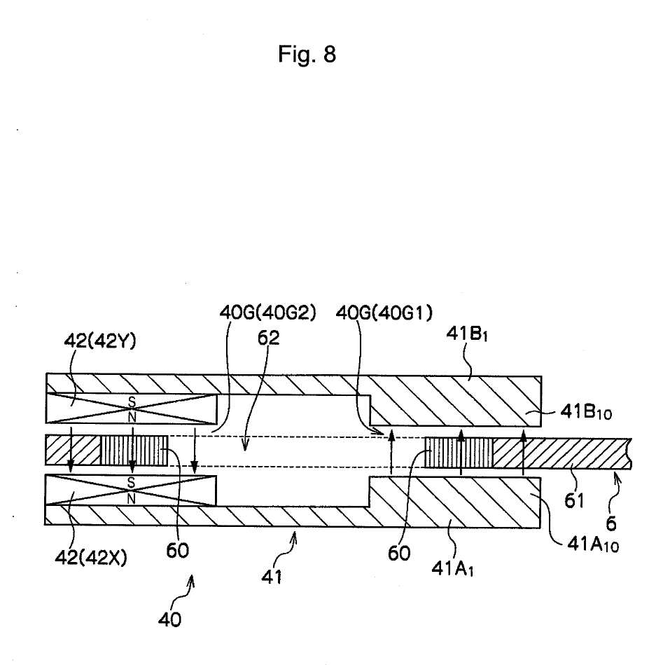

FIGS. 6 to 8 are views illustrating basic configurations of the speaker devices according to other Embodiments of the present invention, showing modified examples of the magnetic circuit 40 (FIG. 6 is an assembled perspective view, FIG. 7 an exploded perspective view and FIG. 8 is a cross-sectional view). The same symbols are applied to the same parts as those described in FIGS. 2 to 5 to avoid repeated descriptions.

In this example, the yoke part 41 of the magnetic circuit 40 includes two yoke parts 41A₁ and 41B₁ oppositely arranged in both sides of the moving space of the voice coil support part 6. And, the yoke parts 41A₁, 41B₁ include support parts 41A₁₁, 41B₁₁ partially projecting toward a direction (for example, Y axial direction) intersecting the vibration direction of the voice coil support part 6 (X axial direction). With the support parts 41A₁₁, 41B₁₁ supported by the frame 3, the two yoke parts 41A₁, 41B₁ are arranged at a predetermined interval from each other.

Also, the yoke parts 41A₁ and 41B₁ include protruding parts 41A₁₀ and 41B₁₀ projecting toward the magnetic gap 40G, and a magnetic gap 40G1 is formed between the protruding parts 41A₁₀ and 41B₁₀ and another magnetic gap 40G2 is formed between the magnets 42X and 42Y which are connected with the yoke part 41A₁ and 41B₁ respectively.

In the above-mentioned magnetic circuit 40, the magnets 42X and 42Y not yet magnetized are connected with the yoke parts 41A₁ and 41B₁ and supported by the frame 3, and then the magnets 42X and 42Y are magnetized in the similar magnetic flux direction in a state where the given magnetic gaps 40G1 and 40G2 are held. As such, a pair of magnetic gaps, each magnetic gap having a different magnetic flux direction are formed side by side in the vibration direction of the voice coil support part 6 with a one-time magnetization process.

### [Operation]

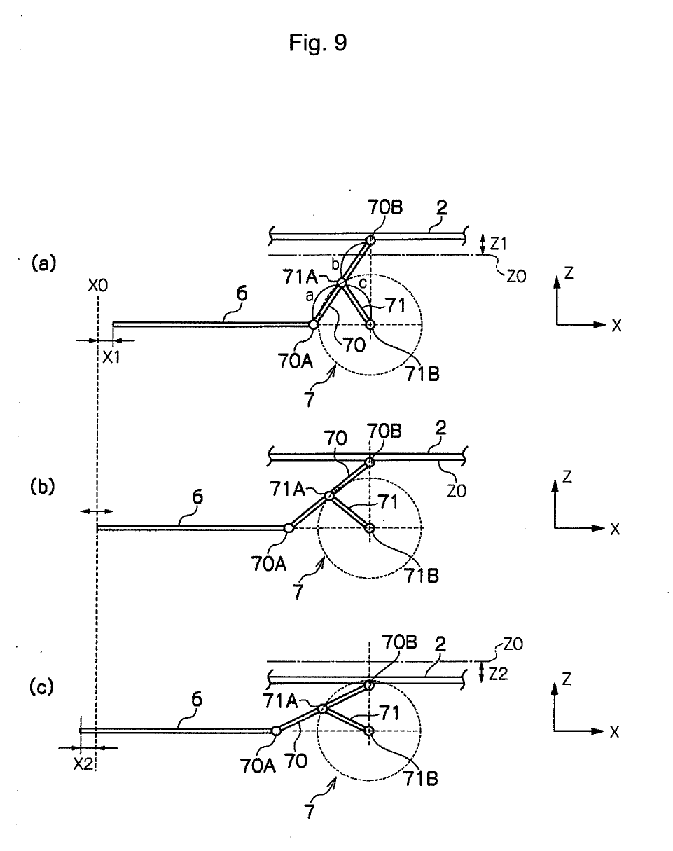

FIG. 9 is a view illustrating an operation of the speaker device 1 according to an embodiment of the present invention. Specifically, FIG. 9(b) is a view illustrating a state of the vibration-direction-conversion part 7 when the diaphragm 2 is placed at a reference position. FIG. 9(a) is a view illustrating a state of the vibration-direction-conversion part 7 when the diaphragm 2 is displaced to the sound emission side with respect to the reference position. FIG. 9(c) is a view illustrating a state of the vibration-direction-conversion part 7 when the diaphragm 2 is displaced to the side opposite to the sound emission side with respect to the reference position.

As described above, the hinge part 71B is the only hinge part that is not displaced, which is supported by the frame 3, thus applying the reaction force from the frame 3 to the link body. Accordingly, when the voice coil supporting part 6 moves from the reference position X0 by X1 in the X-axis direction, the angles of the first and the second link parts 70 and 71 obliquely arranged in different directions are increased substantially by the same angle as shown in FIG. 9(a), and the hinge part 70B, receiving the reaction force from the frame at the hinge part 71B, securely pushes up the diaphragm 2 from the reference position Z0 by Z1 in the Z-axis direction. Further, when the voice coil supporting part 6 moves by X2 reversely in the X-axis direction the angles of the first and the second link parts 70 and 71 are decreased substantially by the same angle as shown in FIG. 9(c), and the hinge part 70B, receiving the reaction force from the frame 3 at the hinge part 71B, securely pushes down the diaphragm 2 from the reference position Z0 by Z2 reversely in the Z-axis direction.

The length a of the link part between the hinge parts 70A and 71A, the length b of the link part between the hinge parts 71A and 70B, and the length c of the link part between the hinge parts 71A and 71B are preferably configured to be similar so that the hinge parts 70A and 71B are arranged on a straight line in the moving direction of the voice coil supporting part 6. This link body is well known as Scott Russell linkage where the hinge parts 70A, 70B and 71B lie on a circumference of a circle having the diameter being the length of the first link part 70 (a+b=2a) and having the center at the hinge part 71A. Namely, the angle defined by the line passing the hinge parts 70A and 71B and the line passing the hinge parts 70B and 71B is always a right angle. Therefore, when the voice coil supporting part 6 is moved in the X-axis direction, the hinge part 70B between the first link part 70 and the diaphragm 2 always moves in the Z-axis direction that is perpendicular to the X-axis, thus it is possible to convert the vibration direction of the voice coil supporting part 6 to its perpendicular direction and transmit the vibration to the diaphragm 2.

The speaker device 1, as described above, has the magnetic gap 40G of the magnetic circuit 40 along the direction different from the vibration direction of the diaphragm 2, and transmits the vibration of the voice coil supporting part 6 vibrating along the magnetic gap 40G to the diaphragm 2 through the vibration-direction-conversion part 7. At this time, the vibration direction of the voice coil supporting part 6 is preferably perpendicular to the vibration direction of the diaphragm 2. According to this configuration, width of each part of the speaker device 1 can be accumulated in a direction different from the width direction (vibration direction of the diaphragm 2), the width along the sound emission direction (the total height of the speaker device) can be comparatively small relative to general speaker devices, thus the speaker device 1 can be made thin.

Further, compared with a speaker device transmitting a driving force by utilizing the bending of a flexible member when transmitting a driving force from the voice coil 60 to the diaphragm 2 for example, the speaker device 1 transmits a driving force from the voice coil supporting part 6 to the diaphragm 2 through the mechanical link body. Therefore a delay in response due to distortion of a flexible member is reduced, for example, and it is possible to vibrate the diaphragm 2 with a relatively high sensitivity. Further, since no flexible member frequently causing resonance (especially at a low frequency) is used, it is possible to efficiently transmit a driving force of the driving part 4 to the diaphragm 2.

Further, since the speaker device 1 angle-converts a driving force developed in the voice coil 60 of the driving part 4 and transmits the driving force to the diaphragm 2 through the mechanical link body, the deterioration in the quality of reproduced sound as seen in a capacitive speaker device when producing a large sound can be suppressed. Therefore, it is possible to emit a high quality reproduced sound in a large volume compared with the capacitive speaker device.

Further, the speaker device 1 can be configured to have the planar bottom face 31A, support the diaphragm 2 along the bottom face 31A, and form the magnetic gap 40G along the bottom face 31A, thus enabling to form the whole speaker device 1 to be planar and thin. Furthermore, the vibration-direction-conversion part 7 vibrating the diaphragm 2 in the direction crossing (preferably perpendicular to) the bottom face 31A by receiving the reaction force from the bottom face 31A of the frame 3, the vibration direction of the voice coil supporting part 6 along the magnetic gap 40G does not directly affect the thickness direction of the speaker device 1. Therefore, this configuration enables to make small the total height of the speaker device 1 small, while making the vibration of the voice coil supporting part 6 and the driving force large, and thus enabling both a large volume of sound output and a thin shape of the speaker device. In addition, the voice coil 60 being formed in a shape of a thin plate, it is possible to make a part of the voice coil 60 in the magnetic gap 40G comparatively large by increasing the winding number and thereby obtain a comparatively large driving force.

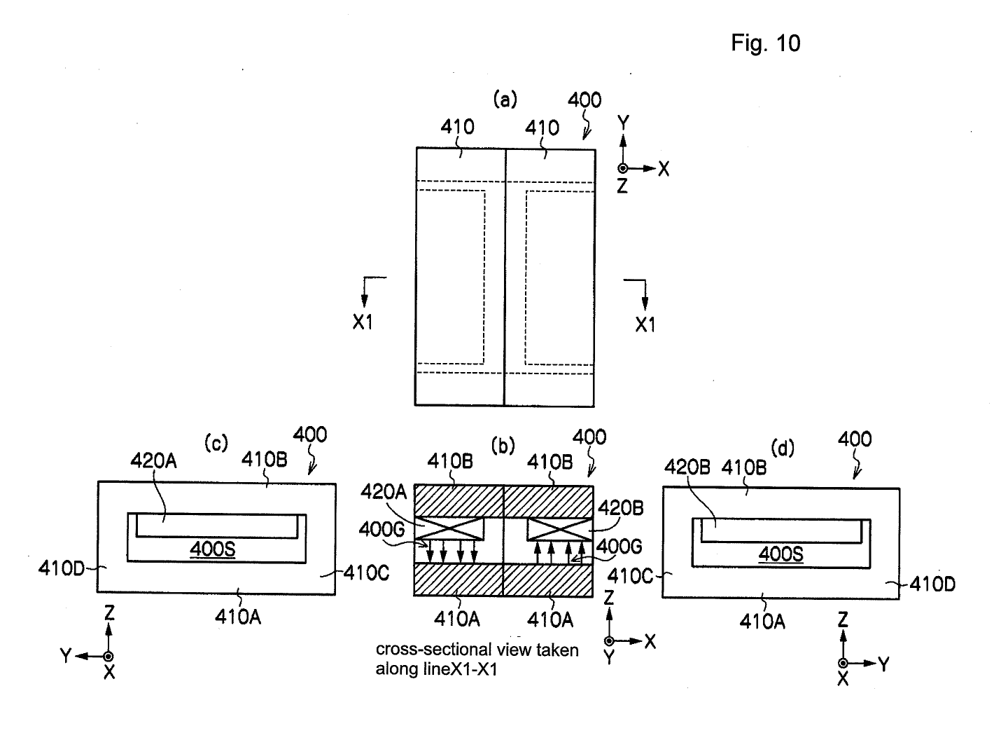

FIGS. 10 to 16 are views illustrating configuration examples of the magnetic circuit according to the Embodiment of the present invention. In the magnetic circuit 400 according to the Embodiment of the present invention, the voice coil 60 supported by the voice coil support part 6 is arranged in a planar state so as to itinerate in a pair of the magnetic gaps 400G, 400G, and the pair of the magnetic gaps 400G, 400G, each magnetic gap having a different magnetic flux direction are formed side by side in the vibration direction of the voice coil support part 6. Also, any example includes the yoke parts 410A, 410B oppositely disposed in both sides of the moving space 400S of the voice coil support part 6 and the magnet 420 (420A, 420B) arranged such that different magnetic flux directions are formed in the pair of the magnetic gaps 400G, 400G. And, an opening part through which the moving space 400S of the voice coil support part 6 passes is formed, and the voice coil support part 6 extends to the outside from the opening part.

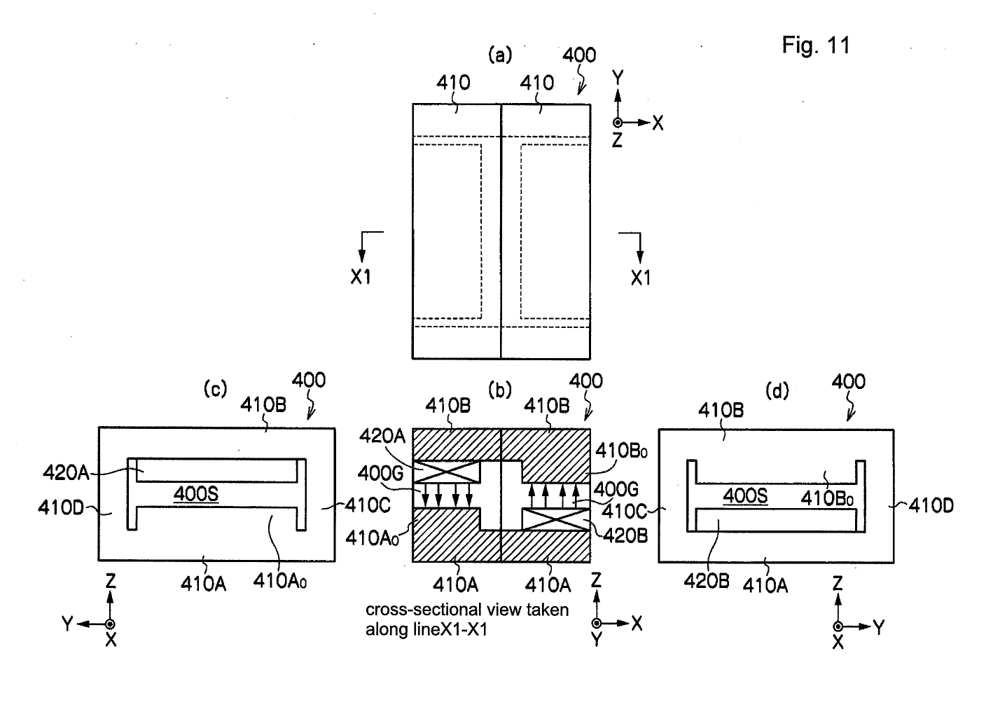

In the examples shown in FIGS. 10 and 11 (FIGS. 10(a) and 11(a) are plan views, FIGS. 10(b) and 11(b) are cross-sectional views taken along line X1-X1, FIGS. 10(c) and 11(c) are rear views and FIGS. 10(d) and 11(d) are front views), the magnetic circuit 400 includes the yoke parts 410A, 410B oppositely arranged in both sides of the moving space 400S of the voice coil support part 6 and the magnets 420A and 420B connected with the yoke parts 410A, 410B, projecting toward the pair of the magnetic gaps 400G, 400G respectively, such that the magnetization directions of the magnets 420A, 420B are formed in the opposite direction in each of the magnetic gaps 400G, 400G. The magnets 420A, 420B are magnetized before two magnetic body parts 410, 410 are connected. Two magnets 420A, 420B are required to be magnetized in the opposite directions, and therefore the magnetization process is required two times.

In the example shown in FIG. 10, the magnetic circuit 400 includes two pieces of magnetic body parts 410, 410 connected to each other, and the magnetic gaps 400G, 400G are formed in the magnetic body parts 410, 410. The magnetic body part 410 includes yoke parts 410A, 410B and side wall parts 410C, 410D so as to surround the moving space 400S of the voice coil support part 6 and both end parts of the yoke parts 410A, 410B are connected at the side wall parts 410C, 410D. And, the magnet 420A is connected with one piece of the yoke part 410A and the magnet 420B is connected to another piece of the yoke part 410B. The pair of the magnetic gaps 400G, 400G, each magnetic gap having a different magnetic flux direction are formed between the magnet 420A and the yoke part 410A and, between the magnet 420B and the yoke part 410A respectively. The yoke parts 410A, 410B, 410C and 410D may be formed with different members, or may be integrally formed with a single member.

In the magnetic circuit 400, the magnets 410A, 410B are required to be magnetized in the opposite directions, thus the magnetization process is required two times. A preferable symmetric distribution of magnetic flux can be obtained in the vibration direction of the voice coil support part 6 in the pair of magnetic gaps 400G, 400G. With this configuration, when voice currents flow in the voice coil 60 arranged in each of the magnetic gaps 400G, nearly the same electromagnetic force (Lorentz force) can be exerted to the voice coils 60.

The distance between the magnets 410A and 410B is preferably established corresponding to the distance between linear portions 60A, 60C of the voice coil 60. The distance between the magnets 410A, 410B and the distance between the linear portions 60A, 60C of the voice coil 60 are established such that linear portions 60A, 60C of the voice coil 60 is positioned in the proximity of the center in the X axial direction of the magnetic gaps 400G, 400G and thereby a large driving force can be applied to the voice coil 60. Further the width of the magnet 410A, 410B in the X axial direction is required to secure amplitude of vibration of the voice coil support part 6. To obtain large amplitude of vibration, the width of the magnets 410A, 410B in the X axial direction need be large. Even when the maximum amplitude of vibration is obtained, the linear portions 60A, 60C of the voice coil 60 are required to stay within the magnetic gaps 400G, 400G respectively. For this purpose, it is required that the distance between the magnets 410A, 410B and the distance between the linear portions 60A, 60C are adjusted.

The magnetic body parts 410, 410 forming the yoke parts 410A, 410B forms an opening part surrounded by the yoke parts 410A, 410B, 410C and 410D, and the moving space 400S of the voice coil support part 6 penetrates along the opening part. The voice coil support part 6 is arranged so as to extend from the opening part to outside.

In the example shown in FIG. 11, similarly to the example shown in FIG. 10, the magnetic circuit 400 forms magnetic gaps 400G, 400G in the magnetic body parts 410, 410 respectively, by connecting the two pieces of magnetic body parts 410, 410. The magnetic body parts 410 includes the yoke parts 410A, 410B and the side wall parts 410C, 410D so as to surround the moving space 400S of the voice coil support part 6, and both end parts of the yoke parts 410A, 410B are connected at the side wall parts 410C, 410D. In one piece of the magnetic body parts 410 the magnet 420A is connected with the yoke 410B and in another piece of the magnetic body parts 410 the magnet 420B is connected with the yoke part 410A. Further, in the yoke 410A facing the magnet 420A the protruding part 410A₀ is formed, projecting toward the magnetic gap 400G from the yoke part 410A, and in the yoke 410B facing the magnet 420B the protruding part 410B₀ is formed, projecting toward the magnetic gap 400G from the yoke part 410B.

That is, in the magnetic circuit 400, the magnetic gap 400G is formed between one magnet 420A and the protruding part 410A₀ projecting from the yoke part 410A, and the magnetic gap 400G is formed between one magnet 420B and the protruding part 410B₀ projecting from the yoke part 410B. Further, the yoke parts 410A, 410B, 410C and 410D may be formed with different members or may be integrally formed with a single member.

Also in the magnetic circuit 400, similarly to the example of the magnetic circuit 400 shown in FIG. 10, a preferable symmetric distribution of magnetic flux can be obtained in the vibration direction of the voice coil support part 6 in the pair of magnetic gaps 400G, 400G. As such, when voice currents flow in the voice coil 60 arranged in each of the magnetic gaps 400G, nearly the same electromagnetic force (Lorentz force) can be exerted to the voice coils 60. Although the thickness in the Z axial direction is relatively large compared to the example shown in FIG. 10, the thickness doesn't directly relate to the amplitude of vibration of the voice coil support part 6, and thus even when designing a speaker device with a large amplitude of vibration, the speaker device can be made thin with its own thickness of the magnetic circuit 400 in the Z axial direction.

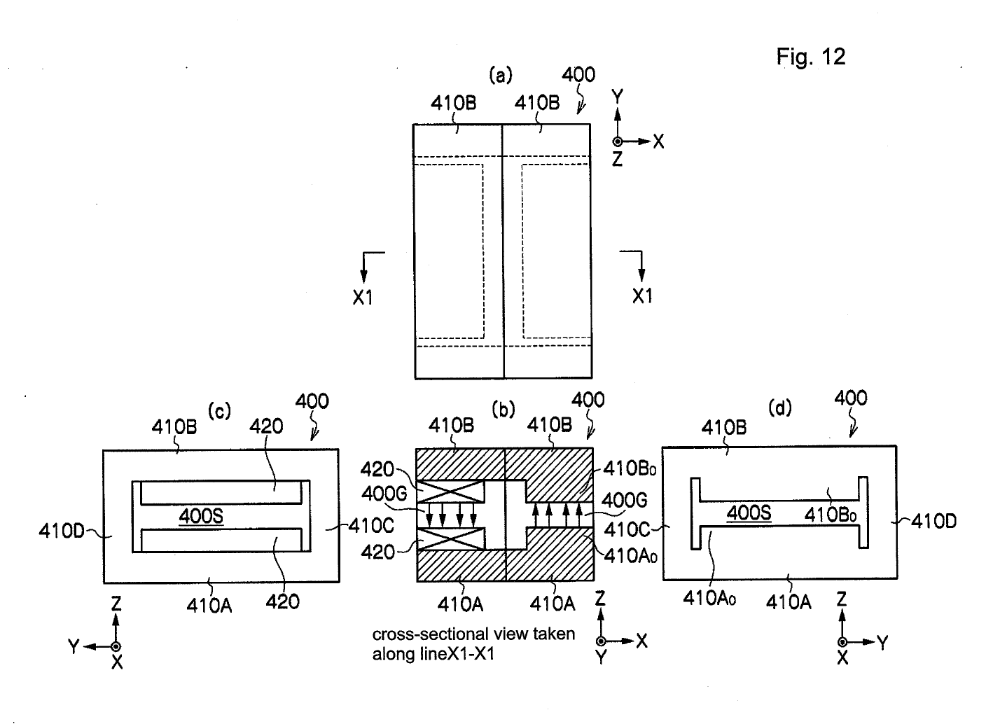

In the example shown in FIGS. 12 to 15, ((a) of each figures is a plan view, (b) of each figures is a cross-sectional view taken along line X1-X1, (c) of each figures is a rear view and (d) of each figures is a front view), the magnetic circuit 400 includes a magnetic body part having yoke parts 410A, 410B oppositely arranged in both sides of the moving space 400S of the voice coil support part 6, and includes magnets 420 connected with yoke parts 410A, 410B, projecting to form one of the pair of the magnetic gaps 400G, 400G, and includes protruding parts (410A₀, 410B₀) projecting from yoke parts (410A, 410B) to form another one of the pair of the magnetic gaps 400G, 400G. In the above examples, with a magnet arranged only in one of the pair of the magnetic gaps 400G, 400G, a magnetization process can be completed at one time, after assembly. Further, with reduced number of magnetization, dust, etc. can be prevented from entering the magnetic circuit, thereby it is possible to improve the reliability of the speaker device 1 and to simplify the manufacturing process.

In the example shown in FIG. 12, the magnetic circuit 400 includes two pieces of the magnetic body part integrally formed with the yoke parts 410A, 410B and the side wall parts 410C, 410D and a pair of the magnets 420, 420. In one piece, the magnets 420, 420 are connected with the yoke parts 410A, 410B respectively, and one magnetic gap 400G is formed between the magnets 420, 420 magnetized in the similar magnetic flux direction. In another piece, the protruding part 410A₀ is formed at the yoke part 410A and the protruding part 410B₀ is formed at the yoke part 410B, and another magnetic gap 400G is formed between the protruding parts 410A₀, 410B₀. Further, each of the yoke parts 410A, 410B, 410C and 410D may be formed with different members.

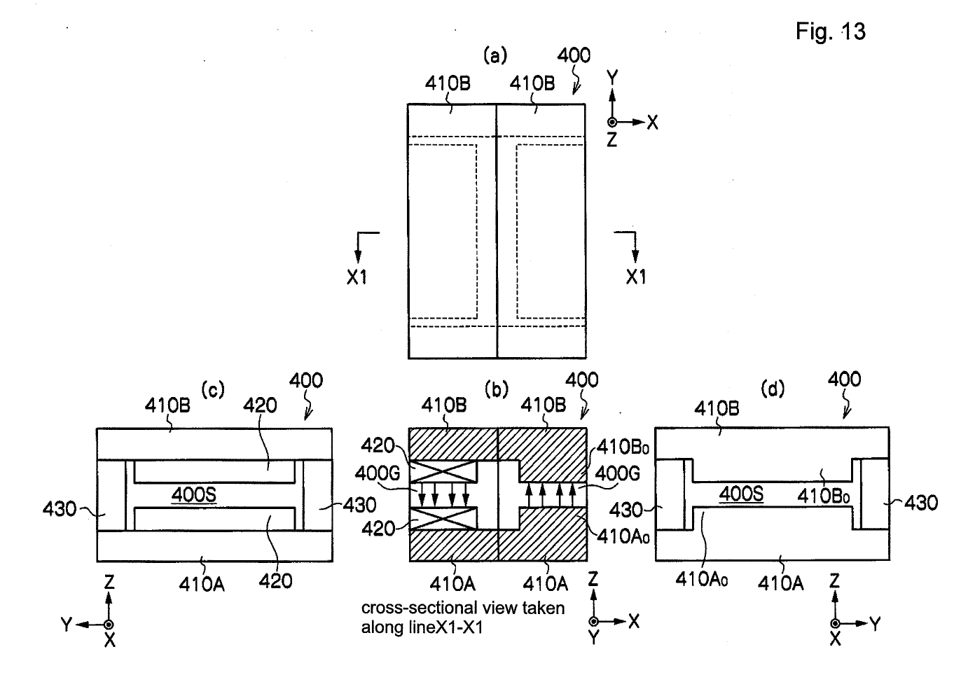

In the example shown in FIG. 13, the magnetic circuit 400 includes the yoke parts 410A, 410A, 410B, 410B formed with four pieces of the magnetic body part respectively and a pair of the magnets 420, 420. Both end parts of the yoke part 410A and the yoke part 410B are supported by a spacer 430 of nonmagnetic body or the frame 3, etc., and are arranged apart. In one supporting structure, the magnets 420, 420 are connected with the yoke parts 410A, 410B respectively, and one magnetic gap 400G is formed between the magnets 420, 420 magnetized in the similar magnetic flux direction. In another supporting structure, a protruding part 410A₀ is formed at the yoke part 410A and the protruding part 410B₀ is formed at the yoke part 410B, and another magnetic gap 400G is formed between the protruding parts 410A₀, 410B₀.

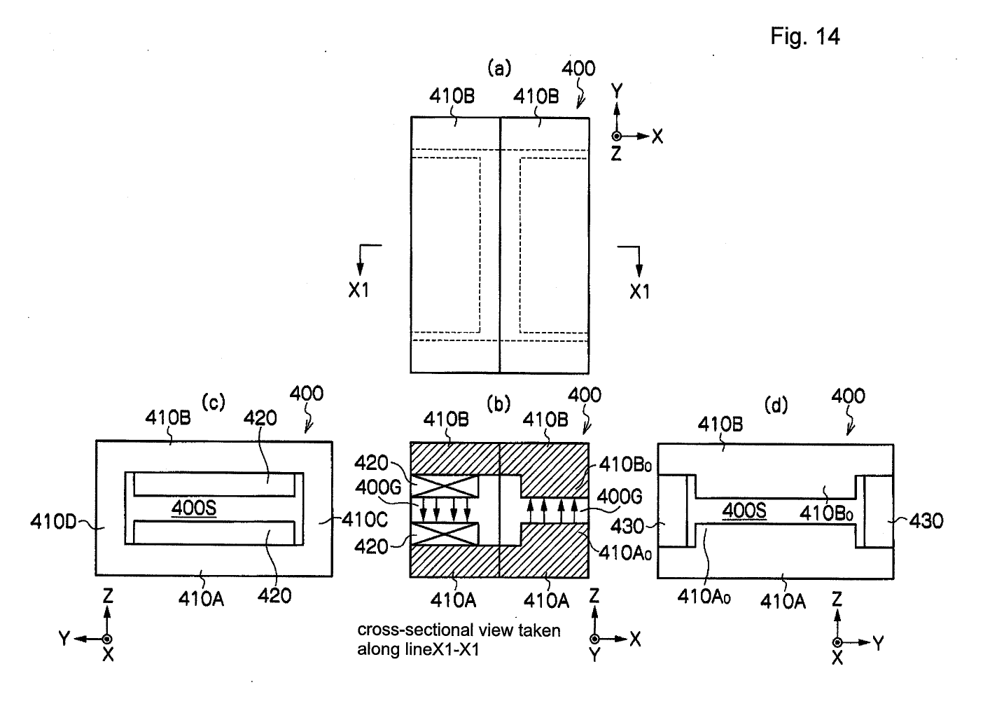

In the example shown in FIG. 14, the magnetic circuit 400 includes one piece of the magnetic body part integrally formed with the yoke parts 410A, 410B, and side wall parts 410C, 410D, two pieces of the magnetic body parts including the yoke part 410A having a protruding part 410A₀ and the yoke part 410B having a protruding part 410B₀ respectively and a pair of the magnets 420, 420. Both end parts of the yoke part 410A and the yoke part 410B formed with two pieces of the magnetic body parts are supported by the spacer 430 of nonmagnetic body or the frame 3, etc., and are arranged apart.

In the one piece of magnetic body part integrally formed with the yoke parts 410A, 410B and side wall parts 410C, 410D, the magnets 420, 420 are connected with the yoke parts 410A, 410B respectively, and one magnetic gap 400G is formed between the magnets 420, 420 magnetized in the similar magnetic flux direction. In a supporting structure using the spacer 430 of nonmagnetic body, another magnetic gap 400G is formed between the protruding parts 410A₀, 410B₀. Further, each of the yoke parts 410A, 410B, 410C and 410D may be formed with different member.

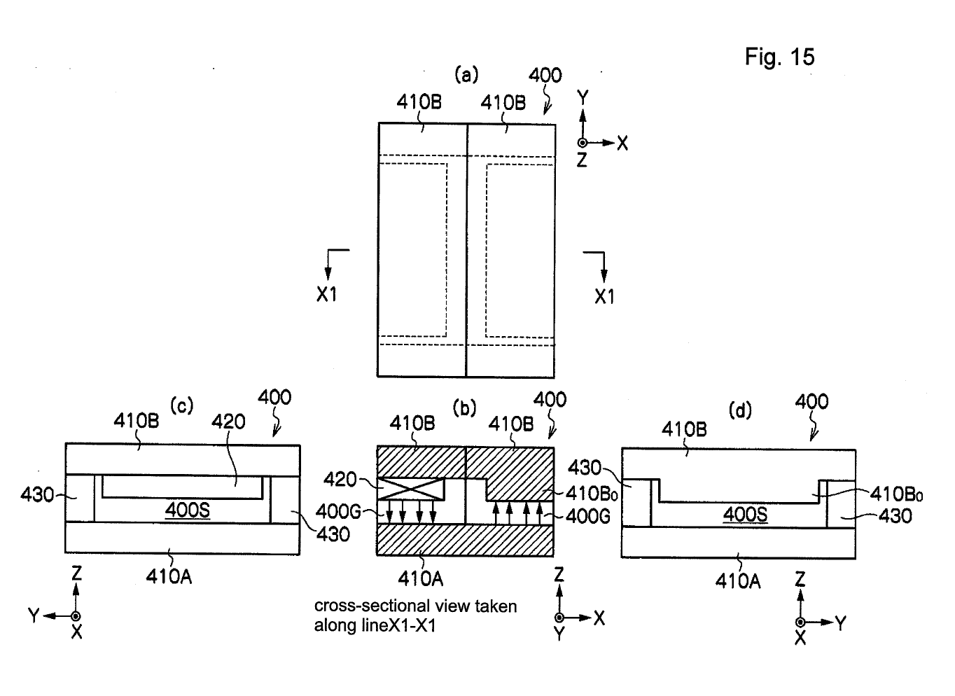

In the example shown in FIG. 15, the magnetic circuit 400 includes two pieces of the magnetic body part forming the tabular-shaped yoke parts 410B and the yoke parts 410B having a protruding part 410B₀ respectively, the yoke part 410A formed with one piece of the magnetic body part, arranged so as to correspond to both yoke parts 410B, 410B, and one magnet 420. Both end parts of the yoke part 410A and the yoke parts 410B, 410B are supported by a spacer 430 of nonmagnetic body or the frame 3, etc. And both end parts of the yoke part 410A and the yoke parts 410B, 410B are arranged apart. One magnetic gap 400G is formed between the magnet 420 and the yoke part 410A and another magnetic gap 400G is formed between the protruding part 410B₀ and the yoke part 410A.

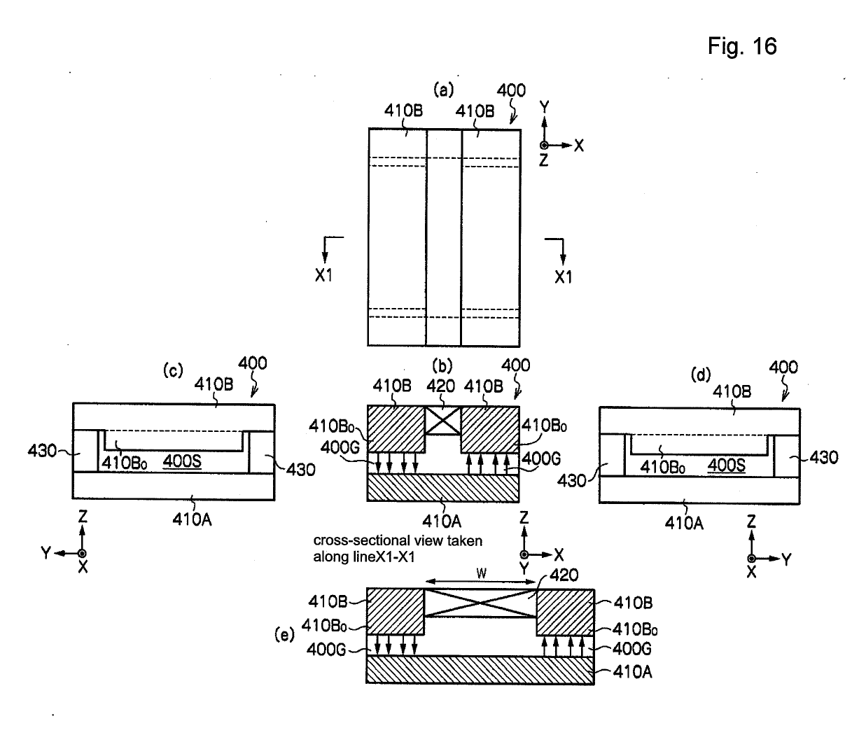

In the example shown in FIG. 16, the magnetic circuit 400 includes two pieces of the magnetic body parts forming the yoke parts 410B having the protruding part 410B₀, the yoke part 410A formed with one piece of the magnetic body part, arranged corresponding to two yoke parts 410B, 410B, and one magnet 420. And, the magnet 420 is arranged between the yoke parts 410B, 410B and a pair of the magnetic gaps 400G, 400G is formed between the protruding parts 410B₀, 410B₀ and the yoke part 410A. FIG. 16(e) shows a modified example in which the length W in the X axial direction of the magnet 420 is large. With the length of the magnet large as shown in the modified example, magnetic flux intensity of the magnetic gaps 400G, 400G can be increased.

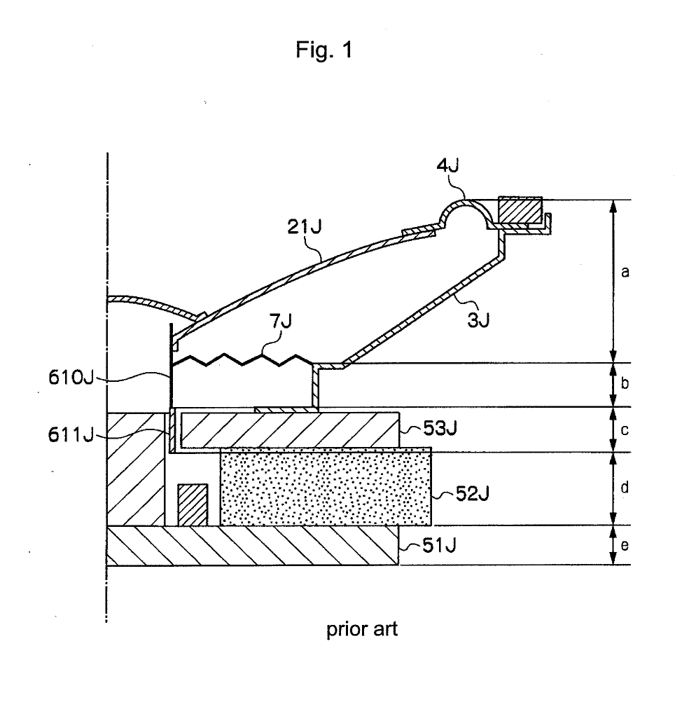

An opening part is formed in the magnetic circuit 400 in the X axial direction of the yoke part 410A, 410B as shown in FIGS. 10 to 16, and the moving space 400S of the voice coil support part 6 penetrates through the opening part. In contrast, in the magnetic circuit of a general speaker device as shown in FIG. 1, one end part of the voice coil in the vibration direction of the voice coil is closed by the yoke 51J. If an opening part is formed in the yoke 51J through which the voice coil bobbin 610J can move, a magnetic force of the magnet 52J cannot be transmitted to a center pole 54J formed inside the voice coil bobbin sufficiently, and thus the magnetic flux density in the magnetic gap formed between the center pole 54J and the plate 53J may decrease. In the magnetic circuit 400 according to the Embodiment of the present invention, even if there is formed an opening part through which the moving space 400S of the voice coil support part 6 penetrates, the magnetic flux density in the magnetic gap 400G can be comparatively large, and thus a large amplitude of vibration of the voice coil support part 6 can be secured without reducing the driving force. Also, with a comparatively large volume of the magnet 420, magnetic flux density in the magnetic gap 400G can be comparatively large, and thus the volume of the magnet 420 can be modified as necessary.

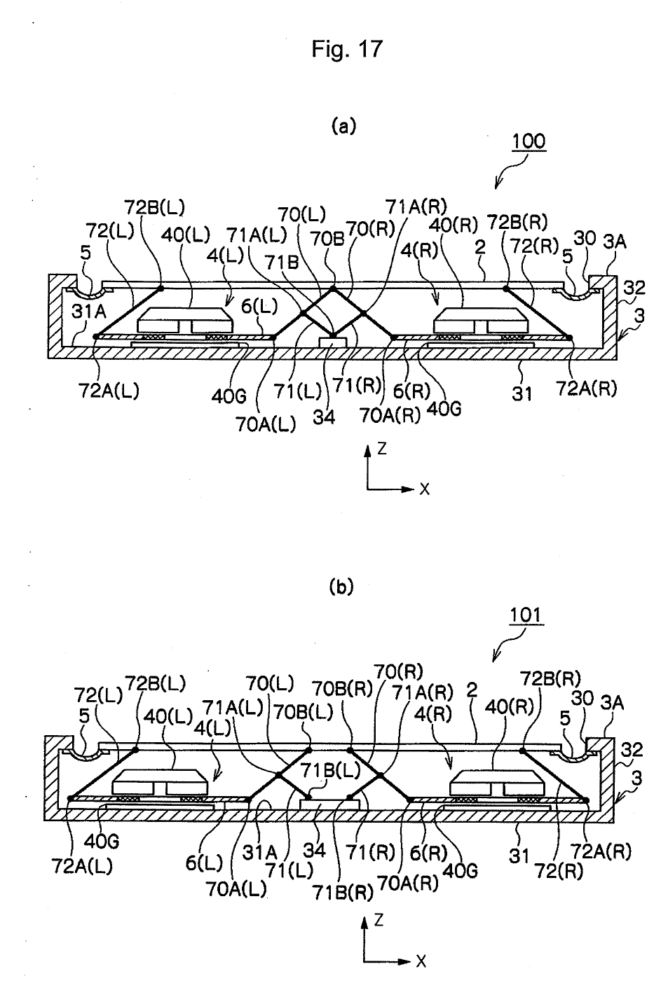

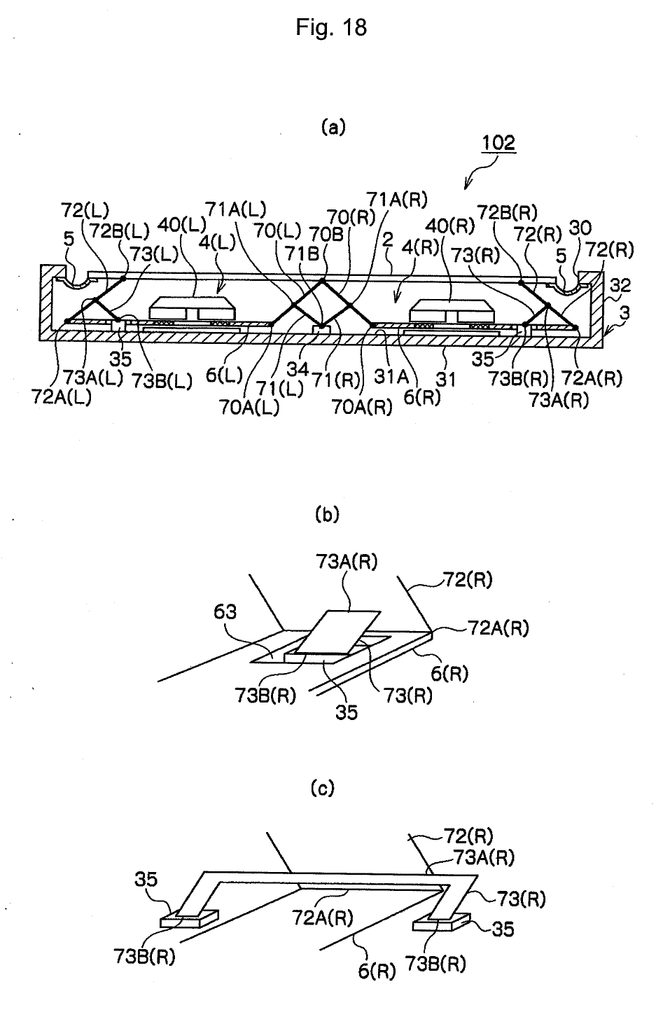

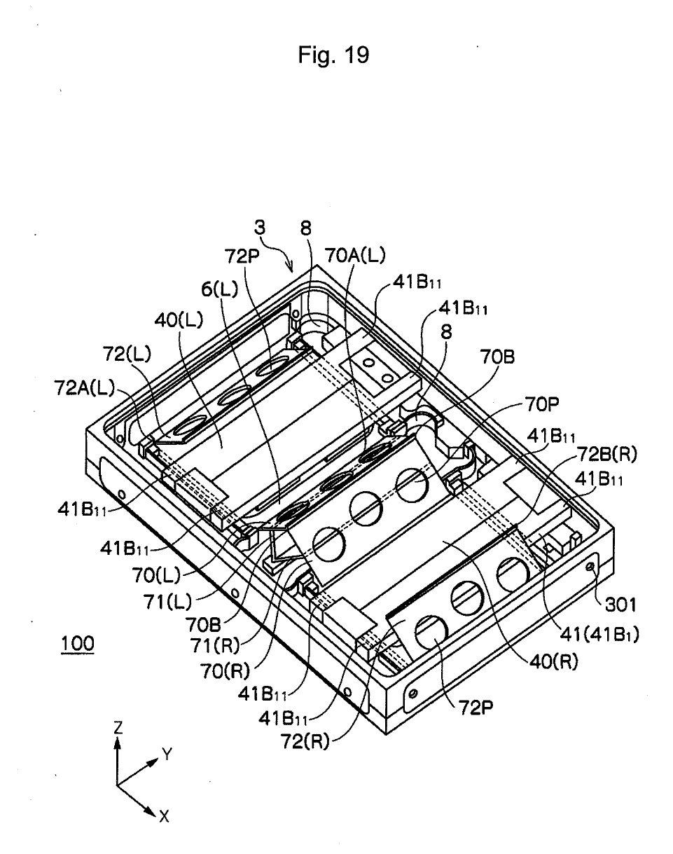

FIGS. 17 to 19 (FIG. 19 is a perspective view of the embodiment shown in FIG. 17) are views illustrating a basic configuration of the speaker device according to an embodiment of the present invention. The same symbols are applied to the same parts and the description is not repeated. The embodiments shown in FIGS. 17(a) and 17(b) and FIG. 18 have two features respectively. One of them is that the vibration direction converter parts 7 is provided at both end parts of the voice coil support part 6 in the vibration direction of the voice coil support part and parallel links are formed with the link parts of the vibration direction converter parts 7 provided at both end parts of the voice coil support part 6. The other feature is that a pair of driving parts 4 is provided and the vibration direction converter parts 7 are left-right symmetrically arranged in the opposite side.

The speaker devices 100 and 101 as shown in FIGS. 17(a) and 17(b) include a pair of right and left driving parts 4(R) and 4(L) respectively to a single diaphragm 2. The driving parts 4(R) and 4(L) are arranged symmetrically. Namely, the driving part 4(R) includes a magnetic circuit 40(R) and a voice coil supporting part 6(R). A first link part 70(R) and a second link part 71(R) are provided on the end of the voice coil supporting part 6(R) on the center side of the diaphragm 2. An outside link part 72(R) is provided on the outside end of voice coil supporting part 6(R) with one end as a hinge part 72A(R) between the outside link part 72(R) and the voice coil supporting part 6(R) and the other end as a hinge part 72B(R) between the outside link part 72(R) and the diaphragm 2. Similarly, the driving part 4(L) includes a magnetic circuit 40(L) and a voice coil supporting part 6(L). A first link part 70(L) and a second link part 71(L) are provided on the end of the voice coil supporting part 6(L) on the center side of the diaphragm 2. An outside link part 72(L) is provided on the outside end of voice coil supporting part 6(L) with one end as a hinge part 72A(L) between the outside the link part 72(L) and the voice coil supporting part 6(L) and the other end as a hinge part 72B(L) between the outside link part 72(L) and the diaphragm 2.

In the vibration-direction-conversion parts provided on the ends of the voice coil supporting part 6(L) and 6(R) on the center side of the diaphragm 2 respectively in the speaker device 100 as shown in FIG. 17(a), the hinge part 70B of the first link parts 70(L) and 70(R) to the diaphragm 2 forms a common part, while the hinge part 71B of the second link parts 71(L) and 71(R) to the frame 3 forms a common part. In this configuration, a rhombic link body is formed with the hinge parts 70B, 71A(R), 71A(L) and 71B and the vibrations of the voice coil supporting parts 6(R) and 6(L) as moving close to and away from each other respectively in the X-axis direction are direction-converted to apply the vibration to the diaphragm 2 in the Z-axis direction (sound emission direction). Also, in this case, the hinge part 71B being supported by the frame 3, the link body constituted by the first link parts 70(R) and 70(L), and the second link parts 71(R) and 71(L) receives the reaction force from the frame 3 corresponding to the vibrations of the voice coil supporting parts 6(R) and 6(L) as moving close to and away from each other, thereby the diaphragm 2 is securely vibrated in the Z-axis direction by this reaction force.

The first link part 70(R) and the outside link part 72(R) provided on both ends of the voice coil supporting part 6(R) in the vibration direction or the first link part 70(L) and the outside link part 72(L) provided on both ends of the voice coil supporting part 6(L) in the vibration direction form a set of parallel links respectively. Accordingly, the first link part 70(R) and the outside link 72(R) disposed substantially in parallel to each other, or the first link part 70(L) and the outside link part 72(L) arranged substantially in parallel to each other, perform an angle-conversion substantially with the same angle corresponding to the movements of the voice coil supporting parts 6(R) and 6(L) in the X-axis direction. Thus, the three hinge parts 70B, 72B(R) and 72B(L) vertically move with the diaphragm 2 being planarly held, enabling a vibration of the diaphragm 2 substantially in the same phase, which can suppress occurrence of divided vibration. At this time, the voice coil supporting parts 6(R) and 6(L) are required to vibrate substantially in the same phase, and the same amplitude, and in opposite directions to each other.

In the speaker device 101 as shown in FIG. 17(b), the hinge part 70B is divided into hinge parts 70B(R) and 70B(L) which are distantly arranged from each other. Similarly, the hinge part 71B is divided into hinge parts 71B(R) and 71B(L) which are distantly arranged from each other. Other than this, the configuration of the speaker device 101 is the same as the speaker device 100 as shown in FIG. 17(a). Accordingly, the speaker device 101 as shown in FIG. 17(b) exhibits similar functions to the speaker device 100 as shown in FIG. 17(a). However, since the speaker device 101 has hinge parts at four positions 70B(R), 70B(L), 72B(R) and 72B(L) concurrently moving vertically to move diaphragm 2 vertically, thereby enabling to suppress the divided vibration of the diaphragm 2 furthermore.

The speaker device 102 according to the embodiment as shown in FIG. 18 is the same as the embodiment shown in FIG. 17 other than the link body of the outside link parts (Although the embodiment shown in FIG. 18 corresponds to the embodiment shown in FIG. 17(a), it may similarly correspond to the embodiment shown in FIG. 17(b) by simply changing the outside link parts. The same symbols are applied to the common parts as those in FIG. 17 not to repeat the same description). FIG. 18(a) is a sectional view of the whole device, and FIGS. 18(b) and 18(c) are views illustrating the hinge part between the outside link part and the frame. The outside link part of this speaker device 102 includes first outside link parts 72(R) and 72(L) and second outside link parts 73(R) and 73(L). A pair of substantially symmetrical driving parts 4(R) and 4(L) is provided here too.

Speaker device 102 includes the first outside link part 72(R) and 72(L) having a hinge part 72A(R) or 72A(L) to the outside portion of the voice coil supporting parts 6(R) or 6(L) at one end, and a hinge part 72B(R) or 72B(L) to the diaphragm 2 at the other end, and the second outside link part 73(R) and 73(L) having a hinge part 73A(R) or 73A(L) to the middle portion of the first outside link part 72(R) and 72(L) at one end, and a hinge part 73B(R) or 73B(L) to the frame 3 at the other end. In this embodiment, the hinge parts 73B(R) and 73B(L) are supported by the frame 3 through a supporting part 35.

The hinge parts 73B(R) and 73B(L) between the second outside link part 73(R) and 73(L), and the frame 3 are described hereinafter. As shown in FIG. 18(b), the voice coil supporting part 6(R) has an opening 63 through which the end of the second outside link part 73(R) may be supported by the frame 3 through the supporting part 35, or it may be supported as shown in FIG. 18(c) where the second outside link part 73(R) has its ends formed in a portal shape with its both ends over the voice coil supporting part 6(R) being supported by the frame 3 through the supporting parts 35 (Although the drawing shows only the example of the right side, the left side is similar to the right side. They are configured almost symmetrically).

According to this embodiment, the link body can be formed to receive the reaction force from the frame 3 in the link parts arranged in outer ends of the voice coil supporting parts 6(R) and 6(L). Accordingly, the first outside link parts 72(R) and 72(L) can be angle-converted by using the reaction force from the frame 3 corresponding to the movement of the voice coil supporting parts 6(R) and 6(L), thereby securely moving the diaphragm 2 up and down.

Since the second link parts 71(R) and 71(L) always receives the reaction force from the frame 3 corresponding to the movement of voice coil supporting parts 6(R) and 6(L) along the X-axis direction, the vertical movement of the voice coil supporting parts 6(R) and 6(L) can be suppressed by the reaction force received from the diaphragm 2 when the link body moves the diaphragm up and down (in the Z-axis direction). This enables a smooth vibration of the voice coil supporting parts 6(R) and 6(L) and a smooth transmission of the vibration to the diaphragm 2.

The support part 41B₁₁ (see FIG. 6) is provided at the yoke part 41 (41B₁) of the magnetic circuit 40(R), 40(L) as shown in FIG. 19, and the support part 41B₁₁ is supported by the frame 3 in the inside of the frame, thereby keeping distance between the arrangements of the yoke parts 41. Further, opening parts 70P, 72P are formed at the first link parts 70(R), (L) and the outside link parts 72(R), (L) as shown in the drawing, and with the opening parts 70P, 72P, the weights of the first link parts 70(R), (L) and the outside link parts 72(R), (L) are reduced, reducing vibration resistance. An opening 301 is formed at the frame 3.

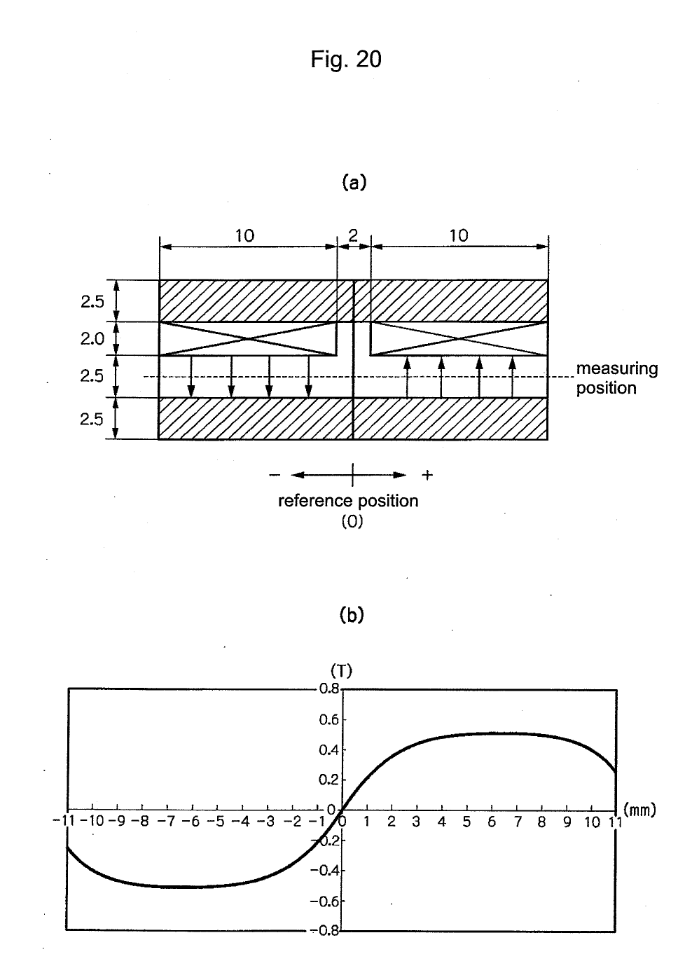

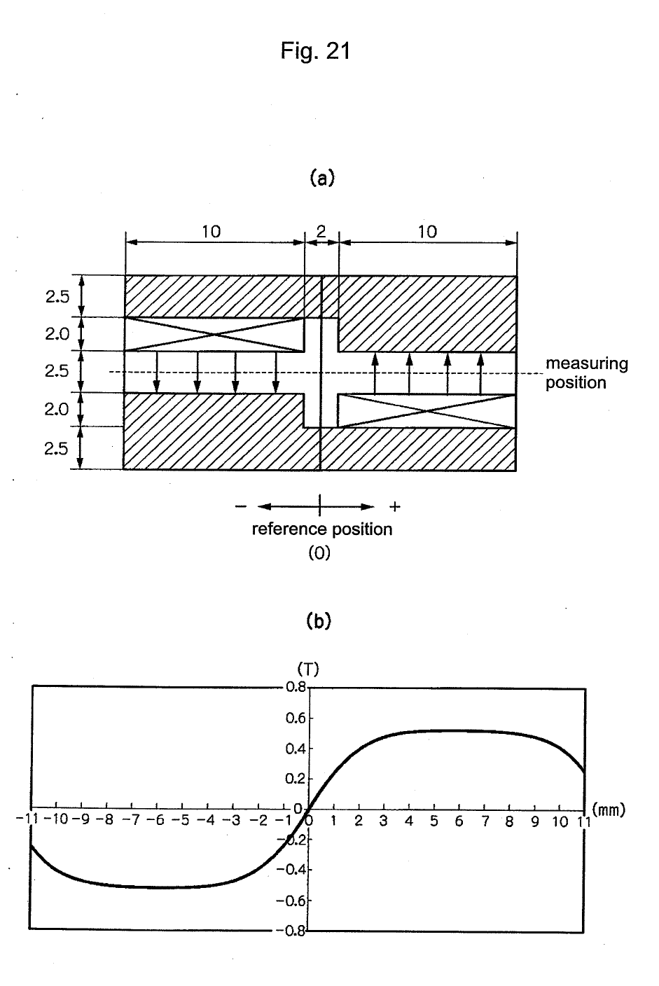

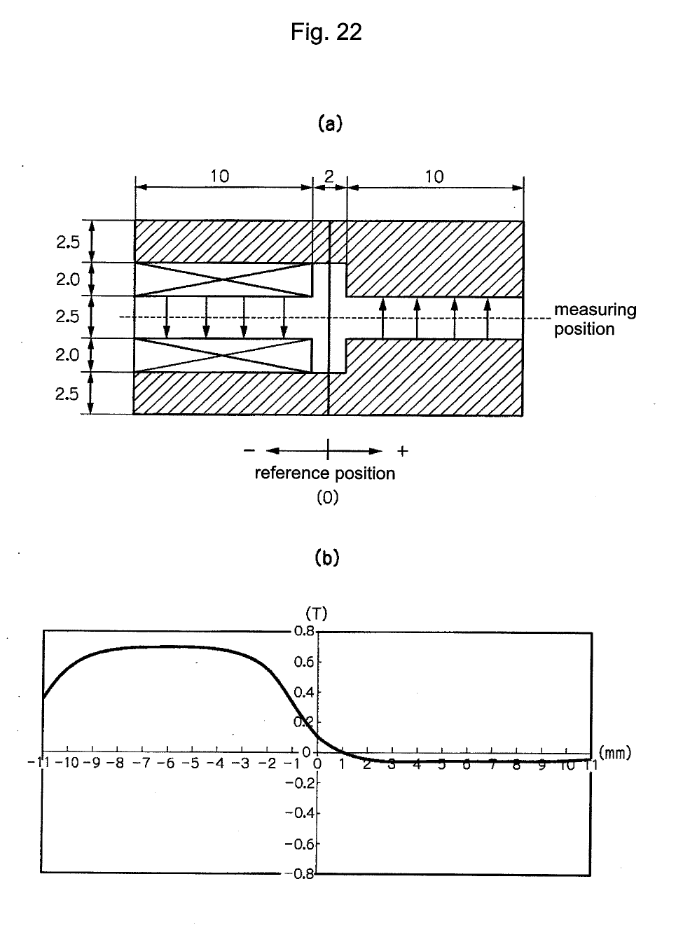

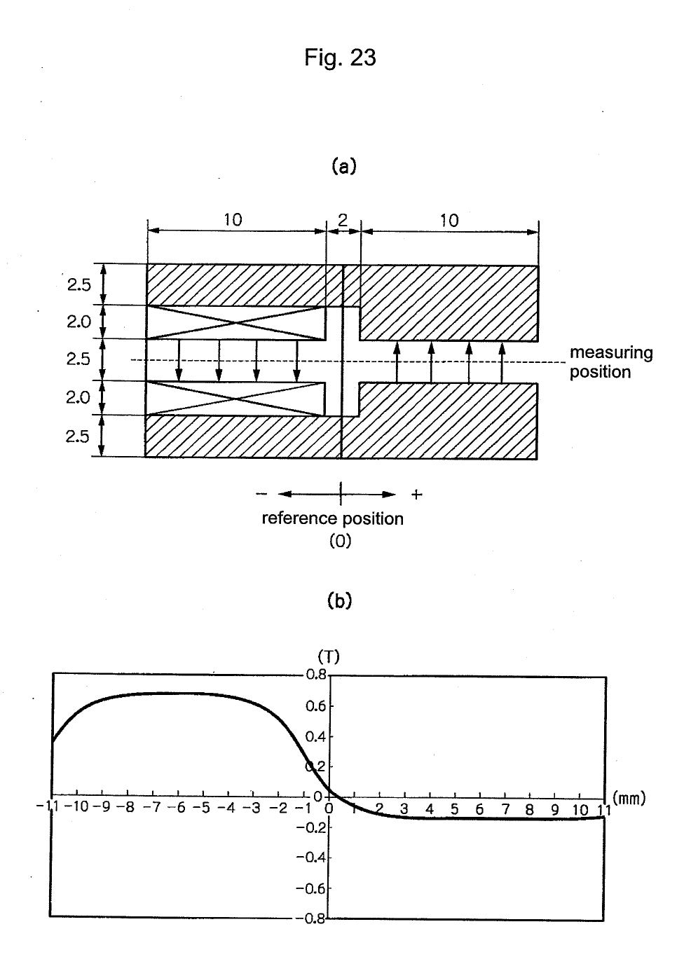

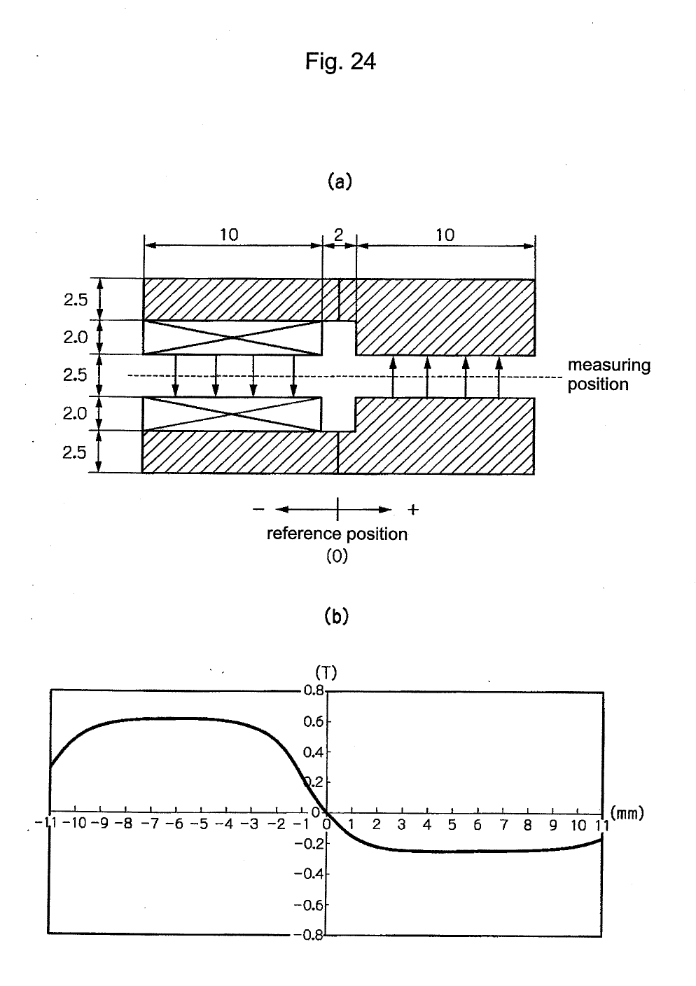

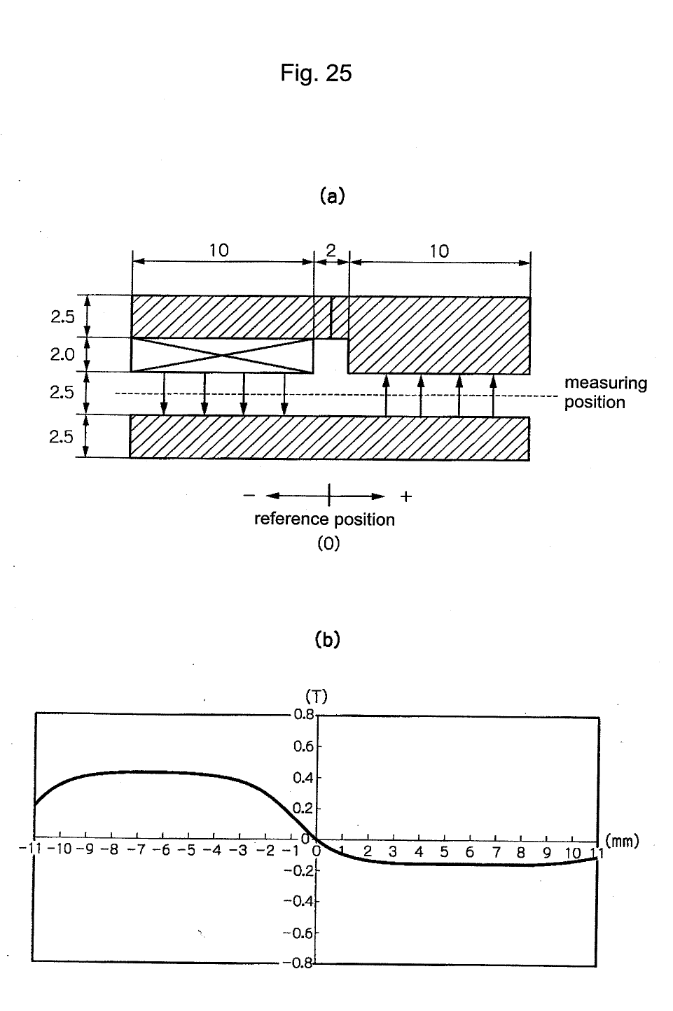

FIGS. 20 to 25 are views illustrating the distribution of the magnetic flux density of the magnetic circuit for the speaker device according to the Embodiment of the present invention (FIGS. 20(a) to 25(a) show the dimensions of each part and FIGS. 20(b) to 25(b) show a graph of the magnetic flux density). FIG. 20 corresponds to the configuration example shown in FIG. 10, FIG. 21 corresponds to the configuration example shown in FIG. 11, FIG. 22 corresponds to the configuration example shown in FIG. 12, FIG. 23 corresponds to the configuration example shown in FIG. 13, FIG. 24 corresponds to the configuration example shown in FIG. 14, and FIG. 25 corresponds to the configuration example shown in FIG. 15. The dimensions in each of FIGS. 20(a) to 25(a) is measured in millimeters, and each graph of FIGS. 20(b) to 25(b) shows the magnetic flux density at a measuring position (center of the magnetic gap) corresponding to a distance from a reference position (center position of the yoke part width) in the X axial direction (vibration direction of the voice coil support part 6).

In the examples shown in FIGS. 20 and 21, a symmetrical magnetic flux density can be obtained at a pair of the magnetic gaps in the vibration direction. In the example shown in FIG. 20, the minimum value on the left hand is −0.52 T, and the maximum value on the right hand is 0.52 T. In the example shown in FIG. 21, the maximum value on the left hand is 0.52 T, and the minimum value on the right hand is −0.52 T.

In the examples shown in FIGS. 22 to 25, asymmetrical magnetic flux distribution can be obtained at a pair of the magnetic gaps in the vibration direction. In the example shown in FIG. 22, the maximum value on the left hand is 0.70 T, and the minimum value on the right hand is −0.055 T. In the example shown in FIG. 23, the maximum value on the left hand is 0.68 T, and the minimum value on the right hand is −0.14 T. In the example shown in FIG. 24, the maximum value on the left hand is 0.64 T, and the minimum value on the right hand is −0.25 T. In the example shown in FIG. 25, the maximum value on the left hand is 0.44 T, and the minimum value on the right hand is −0.14 T. Here, the maximum value and the minimum value are values of magnetic flux density (positive if paper-based direction of magnetic flux density is upward and negative if paper-based direction of magnetic flux density is downward) in the magnetic gap (in the range from ±1 to ±11 mm in respect with a reference position).

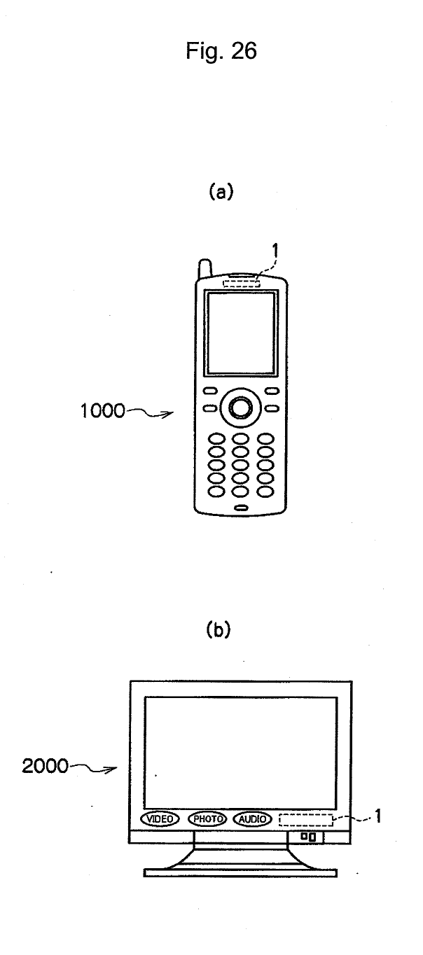

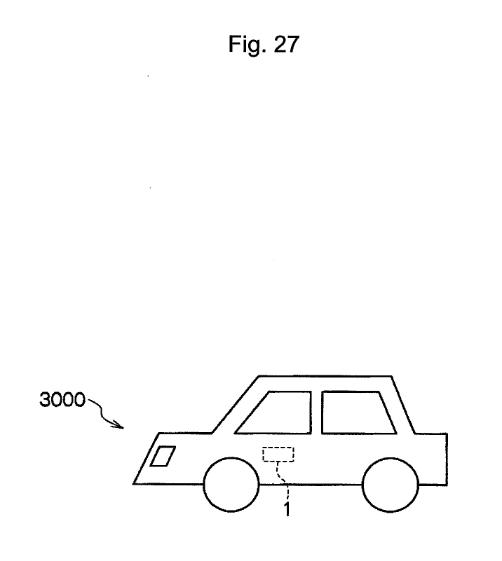

As described above, the speaker device according to the embodiments of the present invention can be made to be thin and capable of producing a large volume of sound. Such a speaker device can be effectively used for various types of electronic devices and in-vehicle devices. FIG. 26 are views illustrating electronic devices including the speaker device according to an embodiment of the present invention. An electronic device 1000 such as a mobile phone or a hand held terminal as shown in FIG. 26(a) or an electronic device 2000 such as a flat panel display as shown in FIG. 26(b) can be configured to reduce a necessary space in thickness for installing the speaker device 1, which enables to reduce the thickness of the whole electronic device. Also, the electronic devices are capable of producing sufficient audio output. FIG. 27 is a view illustrating a vehicle including the speaker device according to an embodiment of the present invention. A vehicle 3000 as shown in the drawing is capable of increasing its in-vehicle space by using the thin speaker device 1. Particularly with a door panel incorporating the speaker device 1 according to the embodiment of the present invention, driver's operation space can be increased by getting rid of a bulge of a door panel. Further, it is possible to comfortably enjoy music or radio broadcasting in the vehicle even during a noisy high-speed driving due to enabling to produce the sufficient audio output.

1. A magnetic circuit for a speaker device transmitting vibration of a voice coil support part supporting a voice coil wound in a plane shape to a diaphragm via a rigid vibration direction converter part, said magnetic circuit for a speaker device planarly vibrating said voice coil support part,
wherein a pair of magnetic gaps with different directions of magnetic flux are arranged side by side in the vibration direction of said voice coil support part.

2. The magnetic circuit for a speaker device according to claim 1, comprising yoke parts oppositely arranged in both sides of a moving space of said voice coil support part, and a magnet arranged so as to generate different directions of magnetic flux in said pair of magnetic gaps.

3. The magnetic circuit for a speaker device according to claim 2, wherein said yoke parts are configured such that end parts of said yoke parts are connected so as to surround the moving space of said voice coil support part.

4. The magnetic circuit for a speaker device according to claim 2, wherein said end of yoke part is supported by a spacer of a nonmagnetic body.

5. The magnetic circuit for a speaker device according to claim 2, wherein at least one of said pair of magnetic gaps is formed between said yoke parts.

6. The magnetic circuit for a speaker device according to claim 2, wherein at least one of said pair of magnetic gaps is formed between two of said magnets.

7. The magnetic circuit for a speaker device according to claim 1, comprising yoke parts oppositely arranged in both sides of a moving space of said voice coil support part, and magnets connected with said yoke parts, wherein said magnets are arranged to project toward said pair of magnetic gaps, and magnetization directions of said magnets in said magnetic gaps are opposite directions.

8. The magnetic circuit for a speaker device according to claim 7, wherein said magnetic gap is formed between said magnet and said yoke part or between said magnet and a protruding part projecting from said yoke part.

9. The magnetic circuit for a speaker device according to claim 1, comprising yoke parts oppositely arranged in both sides of a moving space of said voice coil support part, and a magnet connected with said yoke part, arranged to project so as to form one of said pair of magnetic gaps, and a protruding part projecting from said yoke part so as to form the other of said pair of magnetic gaps.

10. The magnetic circuit for a speaker device according to claim 9, wherein said one magnetic gap is formed between a pair of said magnets, and said other magnetic gap is formed between a pair of said protruding parts.

11. The magnetic circuit for a speaker device according to claim 9, wherein said one magnetic gap is formed between one of said magnets and said yoke part, and said other magnetic gap is formed between one of said protruding parts and said yoke part.

12. A speaker device, comprising:
a driving part including a voice coil wound in a plane shape, a voice coil support part supporting said voice coil and a magnetic circuit planarly vibrating said voice coil support part;
a diaphragm to which vibration of said driving part in response to an audio signal is transmitted;
a frame supporting said driving part and said diaphragm; and
a rigid vibration direction converter part provided between said voice coil support part and said diaphragm, direction converting vibration of said voice coil support part and transmitting said vibration to said diaphragm, wherein
said magnetic circuit includes a pair of magnetic gaps having different directions of magnetic flux, wherein
said pair of magnetic gaps are arranged side by side in the vibration direction of said voice coil support part, and
said voice coil is arranged so as to itinerate in said pair of magnetic gaps.

13. The speaker device according to claim 12, wherein said voice coil has a pair of straight portions arranged substantially parallel, wherein each of said pair of straight portions is arranged to intersect the direction of magnetic flux in said pair of magnetic gaps respectively.

14. The speaker device according to claim 12, wherein said magnetic circuit includes a yoke part and a magnet oppositely arranged in both sides of a moving space of said voice coil support part.

15. The speaker device according to claim 14, wherein said yoke part includes a support part partially projecting in a direction intersecting the vibration direction of said voice coil support part, wherein said support part is supported by the frame.

16. The speaker device according to claim 12, wherein said vibration direction converter part includes a link body that angle converts a link part arranged between said voice coil support part and said diaphragm, wherein said link body angle converts said link part in response to a reaction force exerted from a static part located in the opposite side of said diaphragm.

17. The speaker device according to claim 12, wherein
said vibration direction converter part converts the vibration direction of said voice coil support part to the direction substantially orthogonally thereto and transmits the vibration to said diaphragm.

18. The speaker device according to claim 16, wherein
said static part is part of said frame, and said frame includes a bottom face having a plane shape, and said diaphragm is planarly supported along the bottom face of said frame, and said magnetic gap is formed along the bottom face of said frame, and said vibration direction converter part vibrates said diaphragm in the direction intersecting said bottom face of said frame due to a reaction force from said bottom face.

19. The speaker device according to claim 12, wherein a pair of said driving parts is provided, and said vibration direction converter parts are oppositely arranged to each other.

20. The speaker device according to claim 12, wherein
said diaphragm is supported by said frame via an edge, and said voice coil support part is supported by said frame via a damper.

21. The speaker device according to claim 14, wherein said yoke part forms an opening part, which the moving space of said voice coil support part passes through, and said voice coil support part extends outside from said opening part of said yoke part.

22. The speaker device according to claim 14, wherein said frame is said yoke part constituting said magnetic circuit.

23. The speaker device according to claim 16, wherein
said static part is a part of said yoke part, and said yoke part includes a bottom face having a plane shape, and said diaphragm is planarly supported along the bottom face of said yoke part, and said magnetic gap is formed along the bottom face of said yoke part, and said vibration direction converter part vibrates said diaphragm in the direction intersecting said bottom face of said yoke part due to said reaction force from said bottom face.

24. The speaker device according to claim 12, comprising a signal line electrically connecting said voice coil to an external audio signal source, and said vibration line is wound in said frame.

25. A vehicle comprising the speaker device according to claim 12.

26. An electronic device comprising the speaker device according to claim 12.
